(19) United States
(12) Patent Application Publication
(10) Pub. No.: US 2026/0197494 A1
(43) Pub. Date: Jul. 9, 2026

(54) POINT CLOUD DECODING DEVICE, POINT CLOUD DECODING METHOD, AND NON-TRANSITORY COMPUTER-READABLE MEDIUM

(71) Applicant: KDDI CORPORATION, Tokyo (JP)

(72) Inventors: Yohei HANAOKA, Fujimino-shi (JP); Kyohei UNNO, Fujimino-shi (JP); Keisuke NONAKA, Fujimino-shi (JP); Kei KAWAMURA, Fujimino-shi (JP)

(73) Assignee: KDDI CORPORATION, Tokyo (JP)

(21) Appl. No.: 19/554,462

(22) Filed: Mar. 2, 2026

Related U.S. Application Data
(63) Continuation of application No. PCT/JP2024/041961, filed on Nov. 27, 2024.

(30) Foreign Application Priority Data
Jan. 12, 2024 (JP) 2024-003518

(51) Int. Cl. H04N 19/597; H04N 19/159; H04N 19/174; H04N 19/503

(52) U.S. Cl. CPC H04N 19/597; H04N 19/159; H04N 19/174; H04N 19/503

(57) ABSTRACT

A point cloud decoding device 200 includes: an attribute-information decoding unit 2060 configured to decode a value indicating the number of inter prediction applicability modes in a target slice, wherein the value is set to be equal to a smaller value of a value obtained by subtracting 1 from the number of hierarchies of the target slice and a value obtained by subtracting 1 from the number of hierarchies in which inter prediction of attribute information is enabled.

### CROSS-REFERENCE TO RELATED APPLICATIONS

The present application is a continuation of PCT Application No. PCT/JP2024/041961, filed on Nov. 27, 2024, which claims the benefit of Japanese patent application No. 2024-003518 filed on Jan. 12, 2024, the entire contents of each application being incorporated herein by reference in its entirety.

### BACKGROUND ART

As a conventional technology, there is known a method of predicting an attribute value of a processing target node by referring to an attribute value of a decoded parent node, an adjacent node of the parent node, or an adjacent node in the same hierarchy for intra prediction of the attribute value in decoding attribute information using RAHT, and performing weighting according to an adjacency method.

However, in the conventional technology, since a DC coefficient of a higher-level hierarchy referred to by an intra-predicted value is an average value of child nodes, there is a problem in that it is difficult to accurately predict an original attribute value of the processing target node.

Therefore, the present invention has been made in view of the above-described problems, and an object of the present invention is to provide a point cloud decoding device, a point cloud decoding method, and a non-transitory computer-readable medium, which can improve encoding efficiency in encoding attribute information.

### SUMARY OF THE INVENTION

A first aspect of the present invention is summarized as a point cloud decoding device including: an attribute-information decoding unit configured to decode a value indicating the number of inter prediction applicability modes in a target slice, wherein the value is set to be equal to a smaller value of a value obtained by subtracting 1 from the number of hierarchies of the target slice and a value obtained by subtracting 1 from the number of hierarchies in which inter prediction of attribute information is enabled.

A second aspect of the present invention is summarized as a point cloud decoding method including: decoding a value indicating the number of inter prediction applicability modes in a target slice, wherein the value is set to be equal to a smaller value of a value obtained by subtracting 1 from the number of hierarchies of the target slice and a value obtained by subtracting 1 from the number of hierarchies in which inter prediction of attribute information is enabled.

A third aspect of the present invention is summarized as a non-transitory computer-readable medium having stored thereon a program for causing a computer to function as a point cloud decoding device, wherein the point cloud decoding device includes an attribute-information decoding unit configured to decode a value indicating the number of inter prediction applicability modes in a target slice, and the value is set to be equal to a smaller value of a value obtained by subtracting 1 from the number of hierarchies of the target slice and a value obtained by subtracting 1 from the number of hierarchies in which inter prediction of attribute information is enabled.

According to the present invention, it is possible to provide a point cloud decoding device, a point cloud decoding method, and a non-transitory computer-readable medium, which can improve encoding efficiency in encoding attribute information.

### BRIEF DESCRIPTION OF THE DRAWINGS

FIG. 1 is a diagram illustrating an example of a configuration of a point cloud processing system 10 according to an embodiment.

FIG. 2 is a diagram illustrating an example of functional blocks of a point cloud decoding device 200 according to an embodiment.

FIG. 3 is a diagram illustrating an example of a configuration of encoded data (bit stream) received by a geometry information decoding unit 2010 of the point cloud decoding device 200 according to an embodiment.

FIG. 4 is a diagram illustrating an example of a syntax configuration of a GPS 2011.

FIG. 5 is a diagram illustrating an example of a configuration of encoded data (bit stream) received by an attribute-information decoding unit 2060 of the point cloud decoding device 200 according to an embodiment.

FIG. 6 illustrates an example of a syntax configuration of an APS 2611 illustrated in FIG. 5.

FIG. 7 illustrates an example of a syntax configuration of an ASH 2612 illustrated in FIG. 5.

FIG. 8 is a flowchart illustrating an example of processing of an RAHT unit 2080.

FIG. 9 is a flowchart illustrating an example of processing in step S704.

FIG. 10 is a flowchart illustrating an example of processing of intra prediction in step S28112.

FIG. 11 is a diagram illustrating a relationship between a decoding target node and an adjacent node in a higher-level hierarchy.

FIG. 12 is a diagram illustrating a relationship between a decoding target node and an adjacent node in a subnode hierarchy.

FIG. 13 is a diagram illustrating an example of inter prediction processing in step S28111.

FIG. 14 is a diagram illustrating an example of a syntax configuration in a case where raht_filter_taps is decoded based on raht_inter_skip_layers.

FIG. 15 is a flowchart illustrating an example of slice data decoding processing in step S505.

FIG. 16 is a flowchart illustrating an example of intra prediction in step S703.

FIG. 17 is a flowchart illustrating an example of operation of the tree synthesizing unit 2020 of the point cloud decoding device 200 according to an embodiment.

FIG. 18 is a flowchart illustrating an example of operation of prediction of the position information in step S604.

FIG. 19 is a diagram for describing an example of processing in the tree synthesizing unit 2020 of the point cloud decoding device 200 according to an embodiment.

FIG. 20 is a diagram illustrating an example of functional blocks of a point cloud encoding device 100 according to an embodiment.

### DESCRIPTION OF EMBODIMENTS

An embodiment of the present invention will be described hereinbelow with reference to the drawings. Note that the constituent elements of the embodiment below can, where appropriate, be substituted with existing constituent elements and the like, and that a wide range of variations, including combinations with other existing constituent elements, is possible. Therefore, there are no limitations placed on the content of the invention as in the claims on the basis of the disclosures of the embodiment hereinbelow.

### First Embodiment

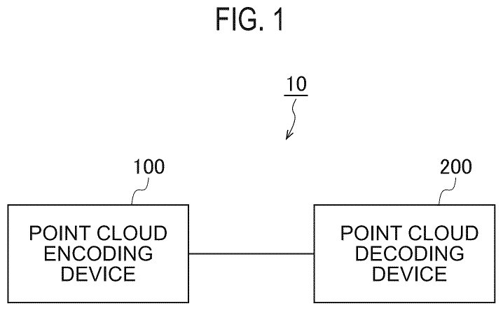

Hereinafter, a point cloud processing system 10 according to a first embodiment of the present invention will be described with reference to FIGS. 1 to 20. FIG. 1 is a diagram illustrating the point cloud processing system 10 according to an embodiment of the present embodiment.

As illustrated in FIG. 1, the point cloud processing system 10 includes a point cloud encoding device 100 and a point cloud decoding device 200.

The point cloud encoding device 100 is configured to generate encoded data (bit stream) by encoding an input point cloud signal. The point cloud decoding device 200 is configured to generate an output point cloud signal by decoding the bit stream.

Note that the input point cloud signal and the output point cloud signal include position information and attribute information of each point in a point cloud. The attribute information is, for example, color information or a reflection ratio of each point.

Here, such a bit stream may be transmitted from the point cloud encoding device 100 to the point cloud decoding device 200 through a transmission path. Furthermore, the bit stream may be stored in a storage medium, and then provided from the point cloud encoding device 100 to the point cloud decoding device 200.

### (Point Cloud Decoding Device 200)

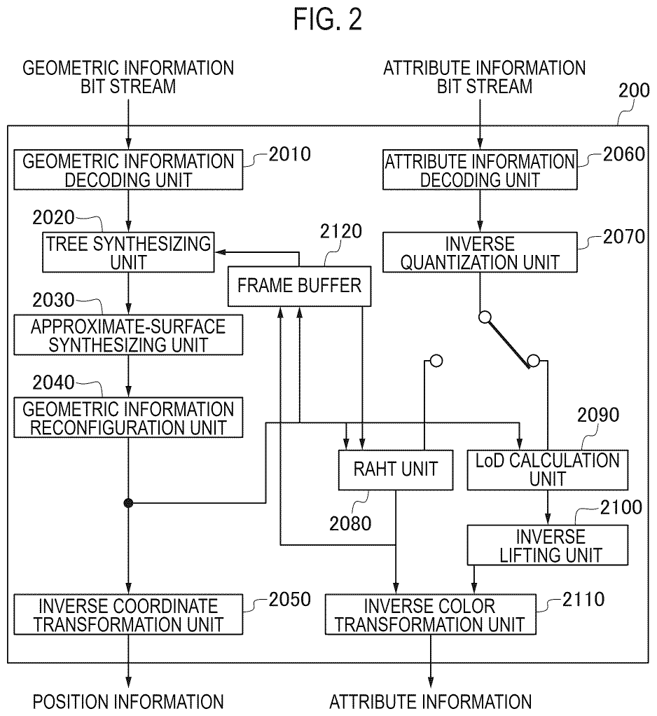

Hereinafter, the point cloud decoding device 200 according to the present embodiment will be described with reference to FIG. 2. FIG. 2 is a diagram illustrating an example of functional blocks of the point cloud decoding device 200 according to the present embodiment.

As illustrated in FIG. 2, the point cloud decoding device 200 includes a geometry information decoding unit 2010, a tree synthesizing unit 2020, an approximate-surface synthesizing unit 2030, a geometry information reconfiguration unit 2040, an inverse coordinate transformation unit 2050, an attribute-information decoding unit 2060, an inverse quantization unit 2070, a region adaptive hierarchical transform (RAHT) unit 2080, a level-of-detail (LoD) calculation unit 2090, an inverse lifting unit 2100, an inverse color transformation unit 2110, and a frame buffer 2120.

The geometry information decoding unit 2010 is configured to use, as input, a bit stream about geometry information (geometry information bit stream) among bit streams output from the point cloud encoding device 100, and to decode syntax.

Decoding processing is, for example, context-adaptive binary arithmetic decoding processing. Here, for example, the syntax includes control data (flags and parameters) for controlling the decoding processing of the position information.

The tree synthesizing unit 2020 is configured to use, as input, the control data, which has been decoded by the geometry information decoding unit 2010, and an occupancy code indicating on which node in a tree described later a point cloud is present, and to generate tree information indicating in which region in a decoding target space points are present.

Note that the tree synthesizing unit 2020 may be configured to perform decoding processing of an occupancy code.

The present process can generate the tree information by recursively repeating processing of partitioning the decoding target space into cuboids, determining whether or not a point is present in each cuboid by referring to the occupancy code, dividing the cuboid in which the point is present into a plurality of cuboids, and referencing the occupancy code.

Here, inter prediction described later may be used in decoding the occupancy code.

In the present embodiment, it is possible to use a method called “octree” in which octree division is recursively carried out with the above-described cuboids always as cubes, and a method called “QtBt” in which quadtree division and binary tree division are carried out in addition to octree division. Whether or not “QtBt” is to be used is transmitted as the control data from the point cloud encoding device 100 side.

Alternatively, the tree synthesizing unit 2020 is configured to, when the control data designates use of predictive geometry coding, decode the coordinates of each point based on an arbitrary tree configuration determined by the point cloud encoding device 100.

The approximate-surface synthesizing unit 2030 is configured to generate approximate-surface information using the tree information generated by the tree synthesizing unit 2020, and decode a point cloud based on this approximate-surface information.

For example, in a case where a point cloud is densely distributed on the surface of an object when decoding three-dimensional point cloud data of the object or the like, the approximate-surface information approximates and expresses a region in which the point cloud is present by a small plane instead of decoding each point cloud.

More specifically, the approximate-surface synthesizing unit 2030 can generate the approximate-surface information and decode the point cloud by, for example, a method called “Trisoup”. A specific “Trisoup” processing example will be described later. In addition, when decoding a sparse point cloud acquired by Lidar or the like, the present processing can be omitted.

The geometry information reconfiguration unit 2040 is configured to reconfigure the geometry information (position information on the coordinate system assumed by the decoding processing) of each point of decoding target point cloud data based on the tree information generated by the tree synthesizing unit 2020 and the approximate-surface information generated by the approximate-surface synthesizing unit 2030.

The inverse coordinate transformation unit 2050 is configured to use, as input, the geometry information reconfigured by the geometry information reconfiguration unit 2040, to transform the coordinate system assumed by the decoding processing into a coordinate system of the output point cloud signal, and to output the position information.

The frame buffer 2120 is configured to use, as input, the geometry information reconfigured by the geometry information reconfiguration unit 2040 to store as a reference frame. The stored reference frame is read from the frame buffer 2130 and used as a reference frame in a case where the tree synthesizing unit 2020 performs inter prediction on temporally different frames.

Here, which time reference frame is used for each frame may be determined based on, for example, control data transmitted as a bit stream from the point cloud encoding device 100.

The attribute-information decoding unit 2060 is configured to use, as input, a bit stream (attribute-information bit stream) about the attribute information among the bit streams output from the point cloud encoding device 100, and to decode syntax.

The decoding processing is, for example, context-adaptive binary arithmetic decoding processing. Here, for example, the syntax includes control data (flags and parameters) for controlling the decoding processing of the attribute information.

Furthermore, the attribute-information decoding unit 2060 is configured to decode quantized residual information from the decoded syntax.

The inverse quantization unit 2070 is configured to perform an inverse quantization process based on the quantized residual information decoded by the attribute-information decoding unit 2060 and quantization parameters that are one of items of the control data decoded by the attribute-information decoding unit 2060, and to generate inverse-quantized residual information.

The inverse-quantized residual information is output to one of the RAHT unit 2080 and the LoD calculation unit 2090 according to a feature of the decoding target point cloud. To which one of the RAHT unit 2080 and the LoD calculation unit 2090 the inverse-quantized residual information is output is designated by the control data decoded by the attribute-information decoding unit 2060.

The RAHT unit 2080 is configured to use, as input, the inverse-quantized residual information generated by the inverse quantization unit 2070, and the geometry information generated by the geometry information reconfiguration unit 2040, and to decode the attribute information of each point by using a type of Haar transformation (that is inverse Haar transformation in the decoding processing) called Region Adaptive Hierarchical Transform (RAHT). As specific processes of the RAHT, for example, the method described in Non Patent Literature 1 (G-PCC codec description, ISO/IEC JTC1/SC29/WG7 N00271) can be used.

The LoD calculation unit 2090 is configured to use, as input, the geometry information generated by the geometry information reconfiguration unit 2040, and to generate a Level of Detail (LoD).

The LoD is information for defining a reference relationship (a point that refers to and a point to be referred to) for implementing predictive coding such as encoding or decoding of a prediction residual by predicting attribute information of a certain point from attribute information of another certain point.

In other words, the LoD is information defining a hierarchical structure in which each point included in the geometry information is classified into a plurality of levels, and for a point belonging to a lower level, an attribute is encoded or decoded using attribute information of a point belonging to an upper level.

As a specific LoD determination method, for example, the method described in Non Patent Literature 1 described above may be used.

The inverse lifting unit 2100 is configured to decode the attribute information of each point based on a hierarchical structure defined by the LoD using the LoD generated by the LoD calculation unit 2090 and the inverse-quantized residual information generated by the inverse quantization unit 2070. As specific processes of inverse lifting, for example, the method described in Non Patent Literature 1 described above can be used.

The inverse color transformation unit 2110 is configured to, when the attribute information of the decoding target is the color information, and color transformation has been carried out on the point cloud encoding device 100 side, perform an inverse color transformation process on the attribute information output from the RAHT unit 2080 or the inverse lifting unit 2100. Whether or not to perform the inverse color transformation process is determined according to the control data decoded by the attribute-information decoding unit 2060.

The point cloud decoding device 200 is configured to decode and output the attribute information of each point in the point cloud by the above processes.

### (Geometry Information Decoding Unit 2010)

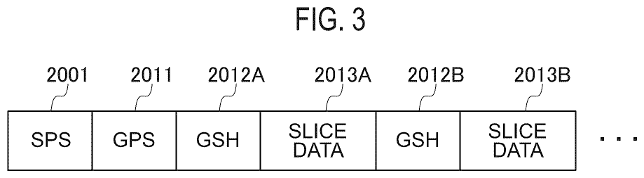

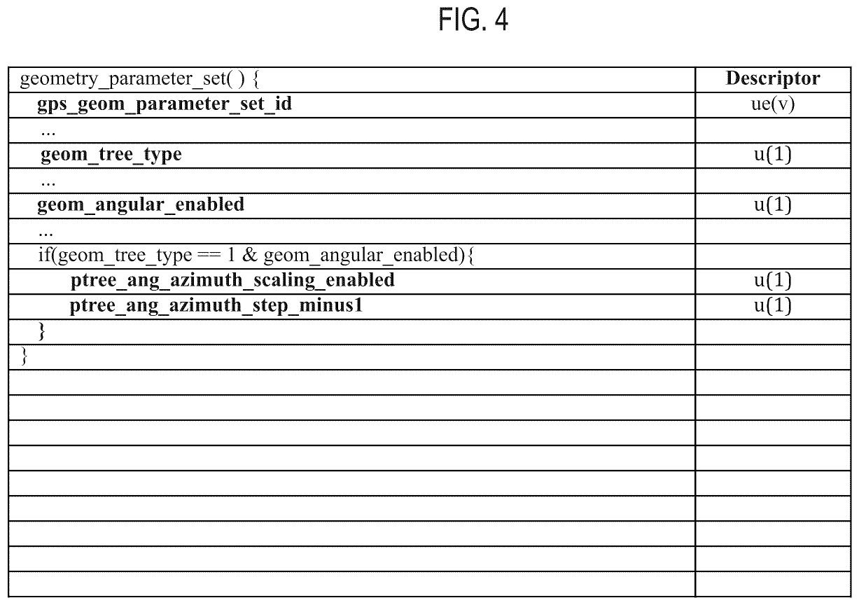

The control data decoded by the geometry information decoding unit 2010 will be described below with reference to FIGS. 3 and 4.

FIG. 3 illustrates an example of a configuration of encoded data (bit stream) received by the geometry information decoding unit 2010.

First, the bit stream may include a GPS 2011. The GPS 2011 is also called a geometry parameter set, and is a set of control data related to decoding of the geometry information. A specific example thereof will be described later. Each GPS 2011 includes at least GPS id information for identifying the individual GPSs 2011 in a case where there are the plurality of GPSs 2011.

Second, the bit stream may include a GSH 2012A/2012B. The GSH 2012A/2012B is also called a geometry slice header or a geometry data unit header, and is a set of control data corresponding to a slice to be described later. Hereinafter, a description will be given using the term “slice”, but the slice may be read as a data unit. A specific example thereof will be described later. The GSH 2012A/2012B includes at least GPS id information for designating the GPS 2011 associated with each of the GSH 2012A/2012B.

Third, the bit stream may include slice data 2013A/2013B in addition to the GSH 2012A/2012B. The slice data 2013A/2013B includes data obtained by encoding the geometry information. An example of the slice data 2013A/2013B includes the occupancy code to be described later.

As described above, the bit stream is configured such that each slice data 2013A/2013B is associated with the GSH 2012A/2012B and the GPS 2011 one by one.

As described above, since which GPS 2011 is referred to in the GSH 2012A/2012B is designated by the GPS id information, the GPS 2011 common to a plurality of items of slice data 2013A/2013B can be used.

In other words, the GPS 2011 does not necessarily need to be transmitted for each slice. For example, the bit stream may be configured such that the GPS 2011 is not encoded immediately before the GSH 2012B and the slice data 2013B as in FIG. 3.

Note that the configuration in FIG. 3 is merely an example. As long as each slice data 2013A/2013B is configured to be associated with the GSH 2012A/2012B and the GPS 2011, an element other than those described above may be added as a constituent element of the bit stream.

For example, as illustrated in FIG. 3, the bit stream may include a sequence parameter set (SPS) 2001. Similarly, the bit stream may have a configuration different from that in FIG. 3 at the time of transmission. Furthermore, the bit stream may be synthesized with a bit stream decoded by the attribute-information decoding unit 2060 described later and transmitted as a single bit stream.

FIG. 4 illustrates an example of a syntax configuration of the GPS 2011.

Note that syntax names described below are merely examples. The syntax names may vary as long as the functions of the syntaxes described below are similar.

The GPS 2011 may include GPS id information (gps_geom_parameter_set_id) for identifying each GPS 2011.

Note that a Descriptor column in FIG. 4 indicates how each syntax is encoded. ue(v) means an unsigned 0-order exponential-Golomb code, and u(1) means a 1-bit flag.

The GPS 2011 may include a flag (geom_tree_type) for controlling a tree type in the tree synthesizing unit 2020.

For example, when the value of geom_tree_type is “1”, it may be defined that Predictive geometry coding is used, and when the value of geom_tree_type is “O”, it may be defined that octree is used.

The GPS 2011 may include a flag (geom_angular_enabled) for controlling whether or not to perform processing in an Angular mode in the tree synthesizing unit 2020.

For example, when the value of geom_angular_enabled is “1”, it may be defined that Predictive geometry coding is performed in the Angular mode, and when the value of geom_angular_enabled is “O”, it may be defined that Predictive geometry coding is not performed in the Angular mode.

The GPS 2011 may include a flag (ptree_ang_azimuth_scaling_enabled) for controlling whether or not an adaptive azimuth angle quantization mode is activated in the Angular mode by the tree synthesizing unit 2020. The adaptive azimuth angle quantization mode is a mode for performing adaptive quantization of an azimuth angle according to a radius.

For example, when the value of ptree_ang_azimuth_scaling_enabled is “1”, it may be defined that the adaptive azimuth angle quantization according to the radius is performed, and when the value of ptree_ang_azimuth_scaling_enabled is “0”, it may be defined that the adaptive azimuth angle quantization according to the radius is not performed.

Furthermore, in the calculation (selection) of the predictor in the angular mode, the flag may be used as a flag for controlling whether to use the predictor list.

For example, when the value of ptree_azimuth_scaling_enabled is “1”, it may be defined that the predictor list is used in the calculation of such a predictor, and when the value of ptree_ang_azimuth_scaling_enabled is “0”, it may be defined that the predictor list is not used in the calculation of such a predictor.

The GPS 2011 may include a value (ptree_ang_azimuth_step_minus1) related to a rotation speed of a laser used to calculate a predicted value of an azimuth angle in the Angular mode by the tree synthesizing unit 2020.

### (Tree Synthesizing Unit 2020)

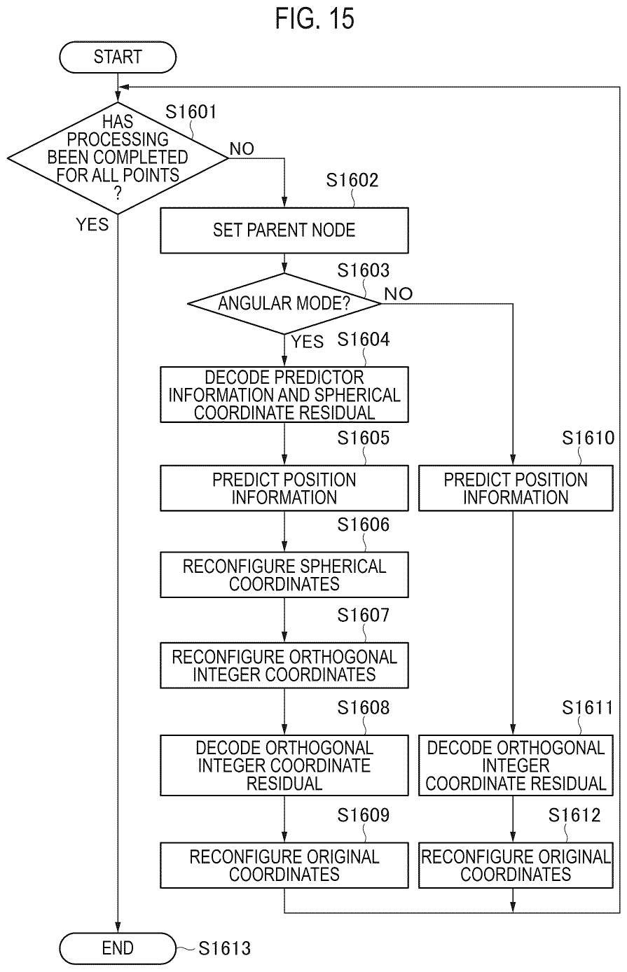

Hereinafter, an example of an operation of the tree synthesizing unit 2020 will be described with reference to FIGS. 15 to 19.

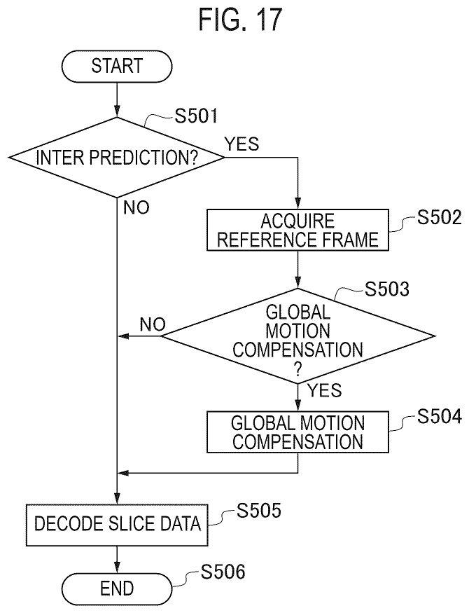

FIG. 17 is a flowchart illustrating an example of processing in the tree synthesizing unit 2020. Note that an example in a case where trees are synthesized using “Predictive geometry coding” will be described below.

The Predictive geometry coding is also called Predictive geometry coding, Predictive geometry or Predictive Tree.

The Predictive geometry coding is a means for decoding a residual of position information predicted based on an arbitrary tree structure determined on a point cloud encoding device 100 side and position information of the point cloud data, and for decoding the position information of the point cloud data by adding both pieces of the position information.

As illustrated in FIG. 17, in step S501, the tree synthesizing unit 2020 determines whether or not to use inter prediction based on the value of interprediction_enabled_flag.

In the case of using the inter prediction, the tree synthesizing unit 2020 proceeds to step S502, and in the case of not using the inter prediction, the tree synthesizing unit 2020 proceeds to step S505.

In step S502, the tree synthesizing unit 2020 acquires the reference frame from the frame buffer 2120.

The frame buffer 2120 may store one previously decoded frame, and addition of the decoded frame to the frame buffer 2120 may be performed every time decoding of one or a specified number of frames is completed. After acquiring the reference frame, the tree synthesizing unit 2020 proceeds to step S503.

In step S503, the tree synthesizing unit 2020 determines whether or not to perform global motion compensation based on global_motion_enabled_flag.

In the case of performing global motion compensation, the tree synthesizing unit 2020 proceeds to step S504, and in the case of not performing global motion compensation, the tree synthesizing unit 2020 proceeds to step S505.

In step S504, the tree synthesizing unit 2020 performs global motion compensation on the reference frame acquired in step S502.

The global motion compensation is processing of correcting a global positional deviation for each frame, and applies rotation and translation based on a global motion vector decoded by the geometric information decoding unit 2010 to all point groups in the reference frame or a point group within a designated range. After the global motion compensation, the tree synthesizing unit 2020 proceeds to step S505.

In step S505, the tree synthesizing unit 2020 decodes the slice data. Specific processing in step S505 will be described later. After decoding the slice data, the tree synthesizing unit 2020 proceeds to step S506. In step S506, the tree synthesizing unit 2020 ends the processing.

Note that the processing in steps S503 and S504, that is, determination and execution of the global motion compensation may be performed during slice data decoding processing in step S505.

FIG. 15 is a flowchart illustrating an example of the slice data decoding processing in step S505 described above.

As illustrated in FIG. 15, in step S1601, the tree synthesizing unit 2020 determines whether or not decoding of the position information of all the pieces of point cloud data included in the slice has been completed.

In the present processing, for example, information indicating the number of pieces of point cloud data included in the slice is transmitted to the GSH, and the number of pieces of point cloud data is compared with the number of pieces of already processed data, so that it is possible to determine whether or not the processing of all the points has been completed.

In a case where the decoding of the position information of all the pieces of point cloud data has been completed, the present operation proceeds to step S1613, and the processing is terminated. In a case where the decoding of the position information of all the pieces of point cloud data has not been completed, the present operation proceeds to step S1602.

In step S1602, the tree synthesizing unit 2020 sets a parent node of a decoding target node (processing target node) of the point cloud data.

For example, the tree synthesizing unit 2020 decodes the number of child nodes for each decoding target node, and stores the index of the decoding target node by the number of child nodes.

Then, in a case where the decoding target node is processed after a certain node, the tree synthesizing unit 2020 may refer to an array of the indexes of the node, acquire one index stored at the end of the array, and set a node of the acquired index as a parent node of the decoding target node.

After the setting of the parent node is completed, the present operation proceeds to step S1603.

In step S1603, the tree synthesizing unit 2020 determines whether or not to perform the processing in the Angular mode.

For example, the tree synthesizing unit 2020 can determine whether or not to perform the processing in the Angular mode by referring to the value of geom_angular_enabled described above.

In the case of performing the processing in the Angular mode, the present operation proceeds to step S1604, and in the case of not performing the processing in the Angular mode, the present operation proceeds to step S1610.

In step S1604, the tree synthesizing unit 2020 decodes predictor information and a spherical coordinate residual used in step S1605. Here, the spherical coordinate residual indicates a residual of the radius, the azimuth angle or the laser ID. After the decoding is completed, the present operation proceeds to step S1605.

In step S1605, the tree synthesizing unit 2020 predicts the position information based on the predictor information decoded in step S504. Here, the predictor information is a predictor index or a prediction mode.

After the prediction of the position information is completed, the present operation proceeds to step S1606.

In step S1606, the tree synthesizing unit 2020 reconfigures spherical coordinates. In such processing, the tree synthesizing unit 2020 reconfigures the spherical coordinates by adding the decoded spherical coordinate residual and the predictor.

After the reconfiguration is completed, the present operation proceeds to step S1607.

In step S1607, the tree synthesizing unit 2020 reconfigures orthogonal integer coordinates. In such processing, the tree synthesizing unit 2020 can convert the spherical coordinates into the orthogonal integer coordinates based on the reconfigured spherical coordinates. As a specific method, for example, the method described in Non Patent Literature 1 can be implemented.

After the reconfiguration of the orthogonal integer coordinates is completed, the present operation proceeds to step S1608.

In step S1608, the tree synthesizing unit 2020 decodes an orthogonal integer coordinate residual.

After the decoding of the orthogonal integer coordinate residual is completed, the present operation proceeds to step S1609.

In step S1609, the tree synthesizing unit 2020 reconfigures the original coordinates. In such processing, the tree synthesizing unit 2020 reconfigures the original coordinates by adding the decoded orthogonal integer coordinate residual and the reconfigured orthogonal integer coordinates.

After the reconfiguration of the original coordinates is completed, the present operation returns to step S1601.

In step S1610, the tree synthesizing unit 2020 predicts the position information. Specifically, the tree synthesizing unit 2020 selects the predictor, and sets the predictor as the predicted value of the position information.

For example, the tree synthesizing unit 2020 may select, based on the decoded predictor mode, the predictor from among the plurality of predictors calculated based on the tree structure.

After the prediction of the position information is completed, the present operation proceeds to step S1611.

In step S1611, the tree synthesizing unit 2020 decodes the orthogonal integer coordinate residual.

After the decoding of the orthogonal integer coordinate residual is completed, the present operation proceeds to step S1612.

In step S1612, the tree synthesizing unit 2020 reconfigures the original coordinates. In such processing, the tree synthesizing unit 2020 reconfigures the original coordinates by adding the orthogonal integer coordinate residual decoded in step S1611 and the position information predicted in step S1610.

After the reconfiguration of the original coordinates is completed, the present operation returns to step S1601.

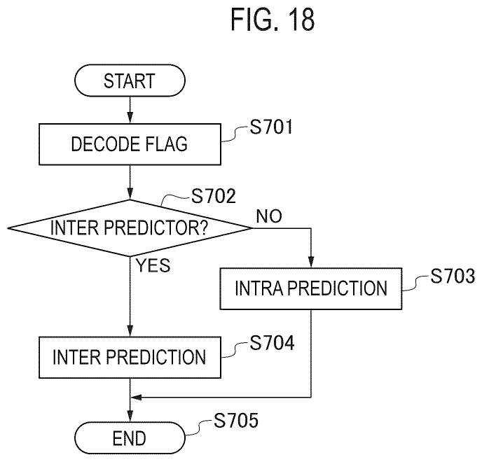

FIG. 18 is a flowchart illustrating an example of processing of predicting the position information in step S1605 described above.

As illustrated in FIG. 18, in step S701, the tree synthesizing unit 2020 decodes a predictor flag.

Here, the slice data may include a flag indicating a predictor to be used for each node. For example, the slice data may include a flag indicating whether a corresponding predictor is an inter predictor or an intra predictor, an index of the inter predictor, and the like, which are similar to the contents described in Non-Patent Literatures 1 and 2. Alternatively, the slice data may include other flags described later.

After decoding the predictor flag, the tree synthesizing unit 2020 proceeds to step S702.

In step S702, the tree synthesizing unit 2020 determines whether or not to use the inter predictor based on the flag decoded in step S701.

In the case of using the inter predictor, the tree synthesizing unit 2020 proceeds to step S704, and in the case of not using the inter predictor, the tree synthesizing unit 2020 proceeds to step S703.

In step S703, the tree synthesizing unit 2020 performs intra prediction on coordinates of the processing target node.

Here, in the intra prediction, the tree synthesizing unit 2020 configures a predictor based on coordinates of a parent or ancestor node (for example, a parent node of a parent node) of the processing target node, and predicts the coordinates of the processing target node. In the processing in step S703, the tree synthesizing unit 2020 first determines a type of the predictor to be used for prediction.

For example, the tree synthesizing unit 2020 may determine whether or not the adaptive azimuth angle quantization mode has been activated based on the value of ptree_ang_azimuth_scaling_enabled, and determine the type of the predictor to be used.

For example, in a case where the adaptive azimuth angle quantization mode has been activated, the tree synthesizing unit 2020 may select, as the type of the predictor, the predictor to be used from among a plurality of predictors calculated using the tree structure based on the decoded prediction mode.

Alternatively, in a case where the adaptive azimuth angle quantization mode has been activated, the tree synthesizing unit 2020 may hold position information of a decoded node as a predictor in a list, refer to a predictor corresponding to a decoded predictor index from the list, and select the predictor to be used.

Once the type of the predictor to be used is determined, the tree synthesizing unit 2020 sets the predictor as a predicted value of the position information.

After the intra prediction is completed, the tree synthesizing unit 2020 proceeds to step S705.

In step S704, the tree synthesizing unit 2020 performs inter prediction on the coordinates of the processing target node.

In such inter prediction, the tree synthesizing unit 2020 selects, as the predictor, a node corresponding to the processing target node from the reference frame, and sets coordinates of the selected predictor as a predicted value of the coordinates of the processing target node. A method of selecting the predictor from the reference frame will be described below.

After completing the inter prediction, the tree synthesizing unit 2020 proceeds to step S705.

In step S705, the tree synthesizing unit 2020 ends the processing in step S1605.

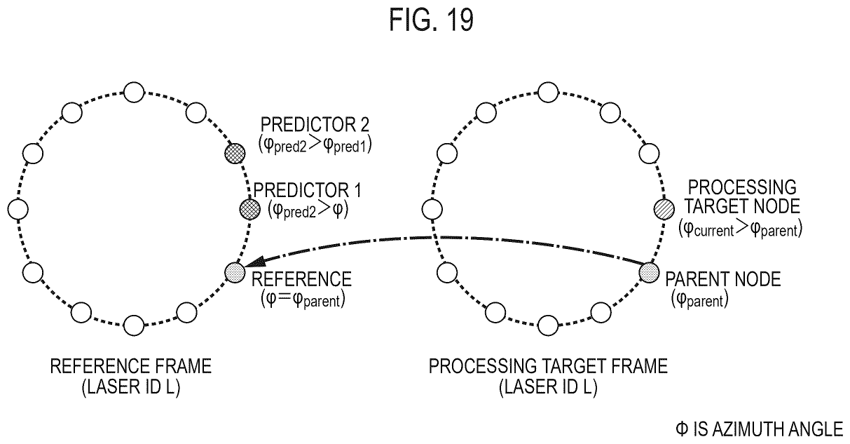

FIG. 19 is a diagram illustrating an example of processing of selecting the predictor from the reference frame in step S704. However, in the example of FIG. 19, it is assumed that the Angular mode is used. In the Angular mode, a point of the parent node of the processing target node may be considered to have been decoded immediately before or at an earlier stage.

In FIG. 19, nodes having the same laser ID as that of the parent node of the processing target node and having a larger azimuth angle than the parent node of the processing target node are searched from the reference frame, and two nodes having the smallest azimuth angle among the nodes are defined as predictor 1 and predictor 2, respectively.

For example, the tree synthesizing unit 2020 may perform bidirectional prediction. Hereinafter, an example of an operation of the tree synthesizing unit 2020 when bidirectional prediction is performed will be described.

First, the tree synthesizing unit 2020 may group a certain number of frames to be processed, and perform processing by changing a processing order in the group.

For example, the tree synthesizing unit 2020 regards eight frames as one group, and performs processing from a frame with an in-group frame index of 0 to a frame with an in-group frame index of 7 in the order of 0, 7, 1, 2, 3, 4, 5, and 6.

Here, the in-group frame index is a number assigned for each order of the frame to be processed in the group.

Furthermore, there may be two reference frames at the time of inter prediction for each processing target frame, and a frame to be referred to may be a future frame in time series.

An in-group frame index order pattern and the frame referred to by each in-group frame index may be decoded as a flag included in an APS 2611 or an ASH 2612.

Here, the in-group frame index order pattern is a pattern of the order of the in-group frame indexes.

In a case where bidirectional prediction is performed, for example, the tree synthesizing unit 2020 may search the two reference frames for nodes having the same laser ID as that of the parent node of the processing target node and having a larger azimuth angle than the parent node of the processing target node, and define, as the predictors, two of the nodes having the smallest azimuth angle from each reference frame, thereby generating four predictors in total. Then, the tree synthesizing unit 2020 may use one of the predictors as the predictor based on the decoded predictor index.

Furthermore, the tree synthesizing unit 2020 may prepare a list of the reference frames for the frame to be referred to by each in-group frame index, and select the frame to be referred to from the list based on a value of the decoded index in the list.

The tree synthesizing unit 2020 may prepare two reference frame lists of the past frames and the future frames in time series based on a corresponding frame to be processed, and may update the reference frame lists at a timing for processing each frame.

Furthermore, the tree synthesizing unit 2020 may fix the frame to be referred to by each in-group frame index for each in-group frame index order pattern and perform hard coding.

For example, in a case where bidirectional prediction is performed, the tree synthesizing unit 2020 may create one predictor from the selected two frames based on the predictor index of each decoded reference frame.

Specifically, the tree synthesizing unit 2020 may use, as the predictor, a linear prediction value of the two frames. That is, the tree synthesizing unit 2020 may use, as the predictor, an average value of the predictors of the two reference frames. Here, the tree synthesizing unit 2020 may use an azimuth angle and a radius as a prediction target. The tree synthesizing unit 2020 may use a value quantized in units of rotation speeds for the azimuth angle. For example, the tree synthesizing unit 2020 may apply a weight according to a distance between the reference frame and the processing target frame.

In the example of FIG. 19, the tree synthesizing unit 2020 searches the reference frame for the nodes having the same laser ID as that of the parent node of the processing target node and having a larger azimuth angle than the parent node of the processing target node, and defines two nodes having the smallest azimuth angle as predictor 1 and predictor 2, respectively.

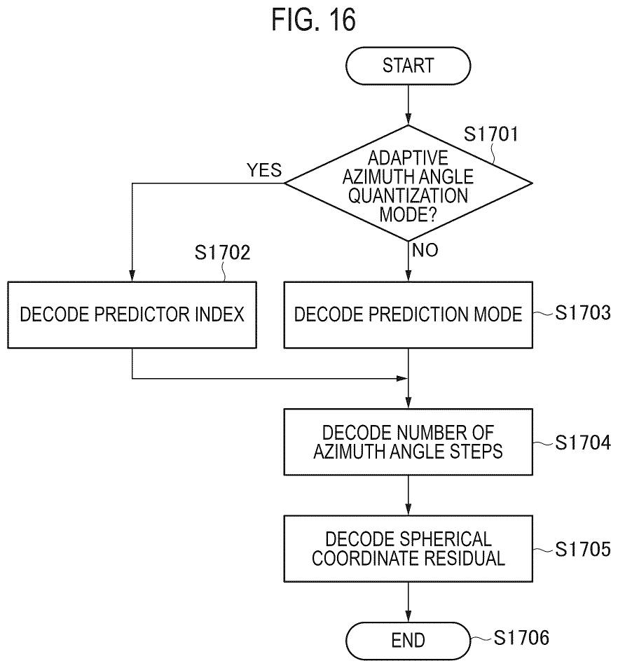

FIG. 16 is a flowchart illustrating an example of processing of intra prediction in step S703.

As illustrated in FIG. 16, in step S1701, the tree synthesizing unit 2020 determines whether or not the adaptive azimuth angle quantization mode has been activated based on the value of ptree_ang_azimuth_scaling_enabled.

In a case where the adaptive azimuth angle quantization mode has been activated, the present operation proceeds to step S602. On the other hand, in a case where the adaptive azimuth angle quantization mode has not been activated, the present operation proceeds to step S1703.

In step S1702, the tree synthesizing unit 2020 decodes the predictor index. After the decoding of the predictor index is completed, the present operation proceeds to step S1704.

In step S1703, the tree synthesizing unit 2020 decodes the prediction mode. After the decoding of the prediction mode is completed, the present operation proceeds to step S1704.

In step S1704, the tree synthesizing unit 2020 decodes the number of azimuth angle steps. After the decoding of the number of azimuth angle steps is completed, the present operation proceeds to step S1705.

In step S1705, the tree synthesizing unit 2020 decodes the spherical coordinate residual. The tree synthesizing unit 2020 may perform such decoding using the method described in Non Patent Literature 2 (G-PCC 2nd Edition codec description, ISO/IEC JTC1/SC29/WG7 N00506). After the decoding is completed, the present operation proceeds to step S1706, and the processing ends.

### (Attribute-Information Decoding Unit 2060)

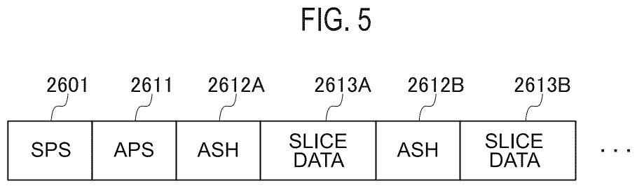

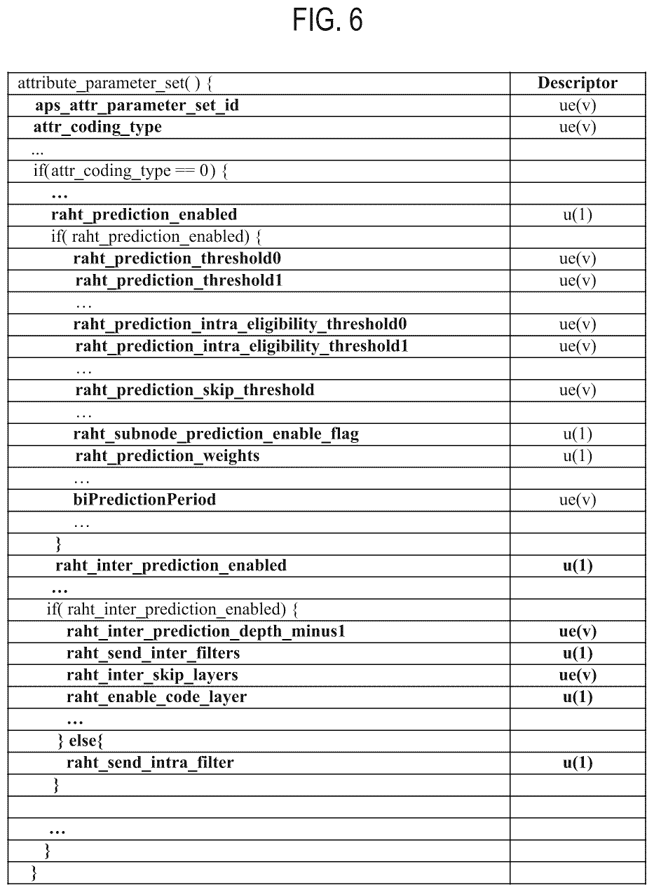

Control data decoded by the attribute-information decoding unit 2060 will be described below with reference to FIGS. 5 and 6.

FIG. 5 is an example of a configuration of encoded data (bit stream) received by the attribute-information decoding unit 2060.

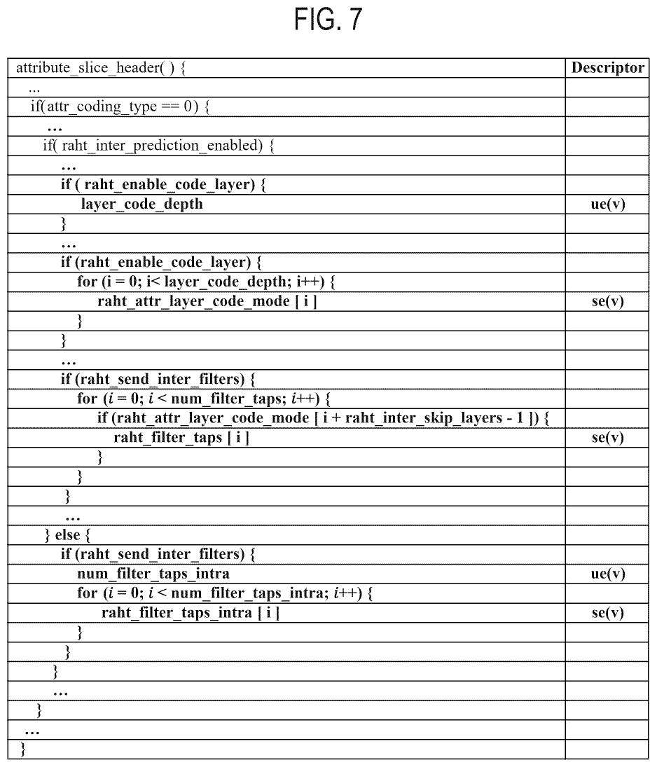

FIGS. 6 and 7 are examples of syntax configurations of the APS 2611 and the ASH 2612.

Note that syntax names described below are merely examples. The syntax names may vary as long as the functions of the syntaxes described below are similar.

The APS 2611 may include APS id information (aps_geom_parameter_set_id) for identifying each APS 2611.

Note that the “Descriptor” field in FIG. 4 indicates how each syntax is encoded. ue(v) means an unsigned 0-order exponential-Golomb code, and u(1) means a 1-bit flag.

The APS 2611 may include a flag (attr_coding_type) for controlling which one of the RAHT unit 2080 and the LoD calculation unit 2090 the inverse quantization unit 2070 outputs inverse-quantized residual information to.

For example, when the value of attr_coding_type is “1”, it may be defined that the inverse-quantized residual information is output to the LoD calculation unit 2090, and when the value of attr_coding_type is “0”, it may be defined that the inverse-quantized residual information is output to the RAHT unit 2080.

The APS 2611 may include a flag (raht_prediction_enabled) for controlling whether the RAHT unit 2080 predicts attribute information.

For example, when the value of raht_prediction_enabled is “1”, it may be defined that attribute information is predicted, and when the value of raht_prediction_enabled is “0”, it may be defined that attribute information is not predicted.

The APS 2611 may include a value (raht_prediction_threshold0) indicating a threshold of the number of adjacent nodes of a grandparent node used by the RAHT unit 2080 to determine whether or not to perform intra prediction of the attribute information. Here, the grandparent node refers to the parent node of the parent node of the processing target node.

The APS 2611 may include a value (raht_prediction_threshold1) indicating a threshold of the number of adjacent nodes of the parent node used by the RAHT unit 2080 to determine whether or not to perform intra prediction of the attribute information.

The APS 2611 may include values (raht_prediction_intra_eligibility_threshold0) and (raht_prediction_intra_eligibility_threshold1) indicating thresholds of values obtained by dividing or subtracting a predicted value of the DC coefficient of the processing target node used by the RAHT unit 2080 to determine whether or not to perform intra prediction of the attribute information and the DC coefficient obtained by RAHT transform.

The APS 2611 may include a flag (raht_subnode_prediction_enable_flag) for controlling whether or not the RAHT unit 2080 uses a subnode to predict the attribute information.

For example, in a case where a value of raht_subnode_prediction_enable_flag is “1”, the APS 2611 may define that the RAHT unit 2080 uses the subnode to predict the attribute information, and in a case where the value of raht_subnode_prediction_enable_flag is “0”, the APS 2611 may define that the RAHT unit 2080 does not use the subnode to predict the attribute information.

The APS 2611 may include a weight parameter (raht_prediction_weights) when the RAHT unit 2080 performs intra prediction of the attribute information.

For example, a value of raht_prediction_weights may be defined according to how the decoding target node is adjacent to the adjacent node used for intra prediction.

The APS 2611 may include a flag (raht_inter_prediction_enabled) for controlling whether or not the RAHT unit 2080 performs inter prediction of the attribute information.

For example, in a case where the value of raht_inter_prediction_enabled is “1”, the APS 2611 may define that the RAHT unit 2080 predicts the attribute information, and in a case where the value of raht_inter_prediction_enabled is “0”, the APS 2611 may define that the RAHT unit 2080 does not predict the attribute information.

The APS 2611 may include a value (raht_inter_prediction_depth_minus1) indicating a hierarchy in which the inter prediction of the attribute information performed by the RAHT unit 2080 is enabled.

For example, when raht_inter_prediction_depth_minus1 is “N−1”, the inter prediction may be enabled in up to the higher N hierarchies of the octree structure.

The APS 2611 may include a value (raht_send_inter_filters) indicating whether or not to transmit a scaling factor in inter prediction of the attribute information.

For example, in a case where raht_send_inter_filters is “1”, the APS 2611 may define that the scaling factor in the inter prediction of the attribute information is to be transmitted, and in a case where raht_send_inter_filters is “0”, the APS 2611 may define that the scaling factor in the inter prediction of the attribute information is not to be transmitted.

For the inter prediction of the attribute information, the APS 2611 may include a value (raht_inter_skip_layers) indicating how many higher layers from a hierarchy of a root node of the octree are excluded from scaling application of the inter prediction. Here, the root node is a node in a state in which octree division has never been carried out in a corresponding slice.

For example, in a case where raht_inter_skip_layers is “3”, the APS 2611 may define that the inter prediction is not applied to the first to third layers.

The APS 2611 may include a value (raht_enable_code_layer) indicating whether or not to transmit an inter prediction applicability mode for each hierarchy. Alternatively, the APS 2611 may include raht_enable_code_layer when raht_prediction_enabled is “1” and raht_inter_prediction_enabled is “1”.

For example, in a case where raht_enable_code_layer is “1”, the APS 2611 may define that the inter prediction applicability mode for each hierarchy is to be transmitted, and when raht_enable_code_layer is “0”, the APS 2611 may define that the inter prediction applicability mode for each hierarchy is not to be transmitted.

The APS 2611 may include a flag (biPredictionPrediod) indicating an attribute information prediction method in the RAHT unit 2080.

For example, in a case where biPredictionPrediod is “O”, the attribute information prediction method may be defined as “no prediction” or “intra prediction”. In a case where biPredictionPrediod is “1”, the attribute information prediction method may be defined as “no prediction”, “intra prediction”, or “inter prediction”. In a case where biPredictionPrediod is “2”, the attribute information prediction method may be defined as “no prediction”, “intra prediction”, “inter prediction”, or “bidirectional prediction”.

The bidirectional prediction will be described later. The attribute information prediction method of “no prediction” indicates that the RAHT unit 2080 uses the decoded AC coefficient as it is for inverse RAHT without predicting the AC coefficient.

The APS 2611 may include a value (raht_send_inter_filters_intra) indicating whether or not to transmit the scaling factor in the intra prediction of the attribute information.

For example, in a case where raht_send_inter_filters_intra is “1”, the APS 2611 may define that the scaling factor in the intra prediction of the attribute information is to be transmitted, and in a case where raht_send_inter_filters_intra is “0”, the APS 2611 may define that the scaling factor in the intra prediction of the attribute information is not to be transmitted.

In a case where raht_inter_prediction_enabled is “1” and raht_enable_code_layer is “1”, the ASH 2612 may include a value (layer_code_depth) indicating the number of inter prediction applicability modes (raht_attr_layer_code_mode) for each hierarchy described later.

Alternatively, in a case where either raht_enable_code_layer or raht_send_inter_filters is “1”, the ASH 2612 may include layer_code_depth.

Alternatively, for example, the ASH 2612 may include layer_code_depth in a case where only raht_send_inter_filters is “1”.

Alternatively, layer_code_depth may be defined as a value obtained by subtracting 1 from the number of hierarchies of the corresponding frame, or may be used by adding 1 after decoding.

Alternatively, in a case where layer_code_depth is “0”, layer_code_depth may be used as “0”, and in a case where layer_code_depth is other than “0”, layer_code_depth may be used by subtracting 1 after decoding.

Alternatively, layer_code_depth may be set to be equal to a smaller value of a value obtained by subtracting 1 from the number of hierarchies of a corresponding slice and raht_inter_prediction_depth_minus1. In a case where raht_enable_code_layer is “1”, the ASH 2612 may include as many inter prediction applicability modes (raht_attr_layer_code_mode) as the number of layer_code_depth for each hierarchy.

For example, in each hierarchy, in a case where inter prediction is applied, “1” may be defined, and in a case where inter prediction is not applied, “O” may be defined.

Alternatively, raht_attr_layer_code_mode may be configured with 3 bits, and a flag indicated by each bit may be defined as follows.

The first bit may be defined as a value indicating “not predicted” or “predicted”, the first bit may be defined as “not predicted” when the first bit is “0”, and the first bit may be defined as “predicted” when the first bit is “1”.

The second bit may be defined as a value indicating “prediction method”, and may be defined as “intra prediction” when the second bit is “0”, and may be defined as “inter prediction” when the second bit is “1”.

The third bit may be defined as a value indicating an “inter prediction method”, and may be defined as “inter prediction” when the third bit is “0”, and may be defined as “bidirectional prediction” when the third bit is “1”.

In addition, the number of bits of raht_attr_layer_code_mode to be decoded may be determined according to the value of biPredictionPrediod.

For example, when biPredictionPrediod is “0”, only the first bit may be decoded as raht_attr_layer_code_mode.

For example, in a case where biPredictionPrediod is “O” and raht_attr_layer_code_mode is “1”, the prediction method may be defined as intra prediction.

When biPredictionPrediod is “1”, only the first bit and the second bit may be decoded as raht_attr_layer_code_mode.

When biPredictionPrediod is “2”, the first, second, and third bits may be decoded as raht_attr_layer_code_mode.

In a case where raht_send_inter_filters is “1”, the ASH 2612 may include as many residuals (raht_filter_taps) from the scaling factor as the number of scaling factors (num_filter_taps) in inter prediction.

As illustrated in FIG. 7, raht_filter_taps may be decoded when raht_attr_layer_code_mode [i+raht_inter_skip_layers-1] is “1” in decoding of raht_filter_taps [i].

An initial value of raht_filter_taps may be defined as “0”.

In a case where raht_attr_layer_code_mode [i+raht_inter_skip_layers-1] is “0”, the initial value “0” may be set as raht_filter_taps [i].

In decoding of raht_filter_taps [i], in a case where raht_inter_skip_layers is “0”, the initial value “0” may be set when i is “0”.

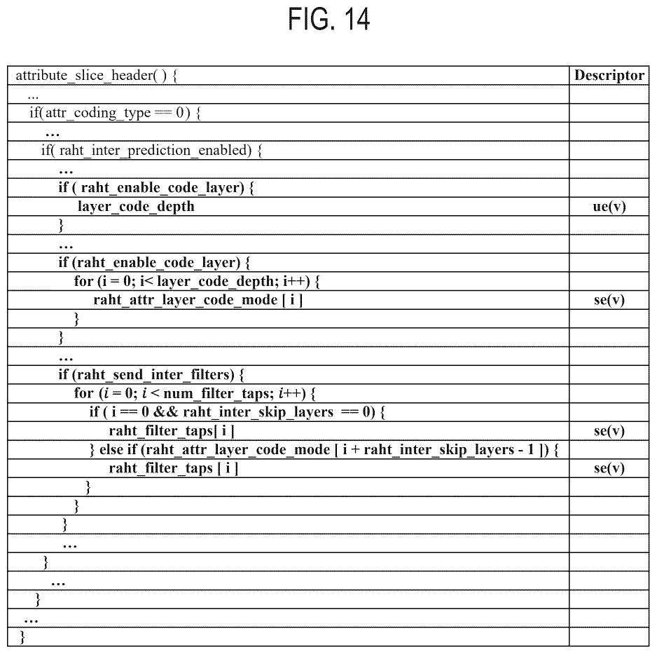

FIG. 14 illustrates an example of a syntax configuration in a case where raht_filter_taps is decoded based on raht_inter_skip_layers.

Hereinafter, only a difference from the syntax configuration described in FIG. 7 will be described. In the decoding of raht_filter_taps [i], in a case where raht_inter_skip_layers is “0”, raht_filter_taps may be decoded even when i is “0”.

num_filter_taps may be derived based on a decoded syntax designating a hierarchy to which inter prediction is to be applied.

Hereinafter, an example of a method of deriving num_filter_taps will be described.

num_filter_taps may be included in the ASH 2612 in a case where raht_enable_code_layer is “0”, or may be derived by the following method in a case where raht_enable_code_layer is “1”.

For example, num_filter_taps may be derived based on a value (raht_inter_skip_layers) indicating how many higher layers are excluded from application of inter prediction scaling, a value (raht_inter_prediction_depth_minus1) indicating the number of valid hierarchies of inter prediction, and a value indicating the number of raht_attr_layer_code_mode (layer_code_depth).

Here, the number of valid hierarchies of inter prediction is a numerical value indicating a threshold for a hierarchy to which inter prediction is applied. For example, the number of valid hierarchies of inter prediction may be a value obtained by adding 1 to raht_inter_prediction_depth_minus1, and when raht_inter_prediction_depth_minus1 is “N−1”, the number of valid hierarchies of inter prediction may be defined as “N”.

Specifically, for example, num_filter_taps may be obtained by subtracting, from the number of valid hierarchies of inter prediction, a value indicating how many higher layers from the number of valid hierarchies of inter prediction are excluded from scaling application of inter prediction in a case where the number of hierarchies of a corresponding frame is larger than the number of valid hierarchies of inter prediction, or may be obtained by subtracting, from a value indicating the number of raht_attr_layer_code_mode, the value indicating how many higher layers from the number of hierarchies are excluded from scaling application of inter prediction in a case where a value indicating the number of raht_attr_layer_code_mode is smaller than the number of valid hierarchies of inter prediction.

That is, num_filter_taps may be derived as follows.

$$\begin{matrix}[ Math . 1 ] & \\ num\_filter \_taps = \{ \begin{matrix}raht\_prediction \_depth \_minus1 + 1 - raht\_inter \_skip \_layers & if raht\_prediction \_depth \_minus1 + 1 < layer\_code \_depth \\ layer\_code \_depth - raht\_inter \_skip \_layers - 1 & if raht\_prediction \_depth \_minus1 + 1 \geq layer\_code \_depth\end{matrix} & \end{matrix}$$

Alternatively, num_filter_taps may be derived as follows regardless of a value of raht_inter_skip_layers or raht_inter_prediction_depth_minus1.

num_filter_taps=layer_code_depth-raht_inter_skip_layers-1

or num_filter_taps may be derived as

num_filter_taps=layer_code_depth-raht_inter_skip_layers, and in this case, when raht_attr_layer_code_mode [i+raht_inter_skip_layers] is “1” in the decoding of raht_filter_taps, raht_filter_taps [i] may be decoded.

Further, the attribute-information decoding unit 2060 may derive the number of scaling factors by using the inter prediction applicability mode for each hierarchy.

Specifically, the attribute-information decoding unit 2060 may count hierarchies to which inter prediction is applied based on, for example, the inter prediction applicability mode for each hierarchy.

However, the attribute-information decoding unit 2060 may exclude a hierarchy to which scaling of inter prediction is not applied from counting based on the value indicating how many higher layers are excluded from scaling application of inter prediction.

Alternatively, the attribute-information decoding unit 2060 may decode the scaling factor only in a case where the corresponding hierarchy is a hierarchy to which inter prediction is applied based on the inter prediction applicability mode for each hierarchy.

However, the attribute-information decoding unit 2060 does not have to decode the hierarchy to which scaling of inter prediction is not applied based on the value indicating how many higher layers are excluded from scaling application of inter prediction.

In a case where raht_send_inter_filters_intra is “1”, the ASH 2612 may include the number of scaling factors in intra prediction (num_filter_taps_intra). The ASH 2612 may include the residuals of the scaling factor (raht_filter_taps_intra) as many as the number of num_filter_taps_intra.

num_filter_taps_intra may be derived based on a decoded syntax designating a hierarchy to which intra prediction is to be applied.

Although an example in which the above-described information is decoded by the APS 2611 has been described above, such information may be included in the ASH 2612 or may be included in the SPS 2601. That is, such information may be included in any header.

### (RAHT Unit 2080)

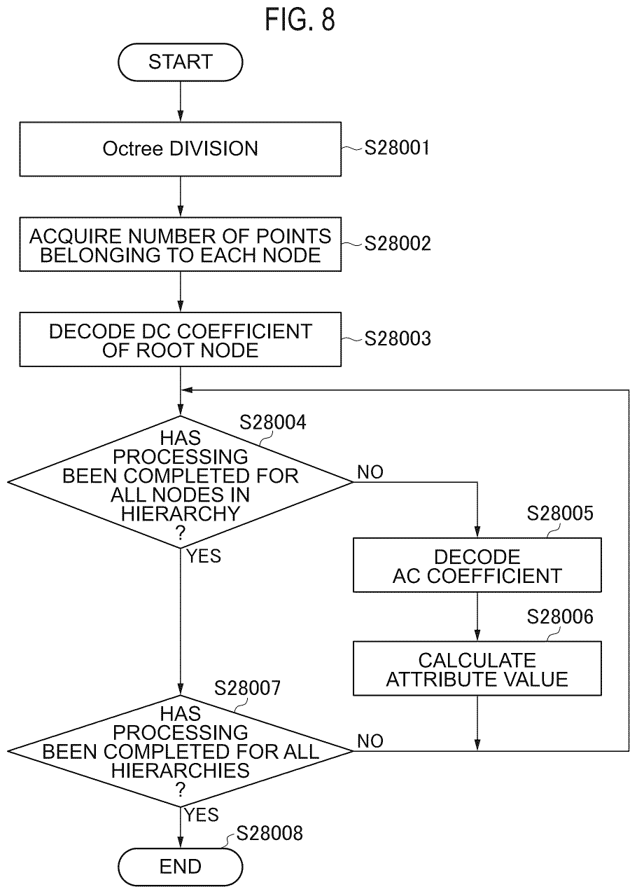

An example of processing of the RAHT unit 2080 will be described with reference to FIGS. 8 to 13.

FIG. 8 is a flowchart illustrating an example of processing of the RAHT unit 2080.

As illustrated in FIG. 8, in step S28001, the RAHT unit 2080 recursively divides a node into eight tree segments until the node has a predetermined size, using a technique called octree. After the division is completed, the present operation proceeds to step S28002.

In step S28002, for each node divided by the octree, the RAHT unit 2080 counts the total number of points belonging to the hierarchy lower than the node.

Specifically, the RAHT unit 2080 sequentially scans nodes in a certain hierarchy and records the number of points belonging to each node. Next, the RAHT unit 2080 adds up the numbers of points recorded in the child nodes of each of the nodes of the one level-higher hierarchy to calculate the number of points belonging to each node.

The RAHT unit 2080 repeats the above scanning in order from the lowest-level hierarchy to the highest-level hierarchy. The acquired total number of points is used as a weight for inverse transform of RAHT in step S28005 to be described later. After the calculation is completed, the present operation proceeds to step S28003.

In step S28003, the RAHT unit 2080 decodes the DC coefficient of the node belonging to the highest-level hierarchy of the octree. Alternatively, the RAHT unit 2080 may calculate the DC coefficient by predicting the DC coefficient using intra prediction, and decoding and adding prediction residuals of the DC coefficient.

After the decoding of the DC coefficient is completed, the RAHT unit 2080 calculates an attribute value Aᵣₒₒₜ of the root node by using the total number wᵣₒₒₜ of points belonging to the root node, which is acquired in step S28002, and the decoded DC coefficient DCᵣₒₒₜ according to the following formula.

$$\begin{matrix}[ Math . 2 ] & \\ {A}_{r o o t} = D {C}_{r o o t} \sqrt{{W}_{r o o t}} & \end{matrix}$$

After the calculation is completed, the present operation proceeds to step S28004.

In step S28004, the RAHT unit 2080 determines whether the decoding of the attribute information has been completed for all the nodes included in the hierarchy.

When the decoding of the attribute information has not been completed for all the nodes included in the hierarchy, the present operation proceeds to step S28005, and when the decoding of the attribute information has been completed for all the nodes included in the hierarchy, the present operation proceeds to step S28007.

In step S28005, the RAHT unit 2080 decodes the AC coefficient. This will be described in detail later. When the decoding of the AC coefficient is completed, the present operation proceeds to step S28006.

In step S28006, the RAHT unit 2080 calculates an attribute value by using inverse transform of RAHT based on the counted total number of points belonging to the hierarchy lower than each node, the decoded AC coefficient, and the DC coefficient calculated from the node of the higher-level hierarchy by the method to be described later.

Here, the inverse transform of RAHT is performed in units of eight nodes (2×2×2) divided into eight tree segments by the octree.

Specifically, attribute values A1, A2, . . . , and Ak are obtained according to the following Formula (1) using the DC coefficients DC of the nodes holding k subnodes, the AC coefficients AC₁, AC₂, . . . , and ACₖ₋₁, and the total numbers W=w₁, w₂, . . . , and wₖ of points belonging to the hierarchy lower than each subnode.

$$\begin{matrix}[ Math . 3 ] & \\ [ \begin{matrix}{A}_{1} / \sqrt{{w}_{1}} \\ ⋮ \\ {A}_{k} / \sqrt{{w}_{k}}\end{matrix} ] = {T ( w )}^{- 1} [ \begin{matrix}D C \\ A {C}_{1} \\ ⋮ \\ A {C}_{k - 1}\end{matrix} ] & ( 1 )\end{matrix}$$

Here, T(w)⁻¹ is a matrix used for inverse transform of RAHT, and can be generated, for example, by the method described in Non Patent Literature 1.

It is assumed that such transform processing is repeatedly performed in order from a node of a higher-level hierarchy to a node of a lower-level hierarchy, and

$${A}_{1} / \sqrt{{w}_{1}} , {A}_{2} / \sqrt{{w}_{2}} , … , {A}_{k} / \sqrt{{w}_{k}} \qquad [ Math . 4 ]$$

which is used as a DC coefficient in the inverse transform of RAHT for each subnode. After the transform processing is completed, the present operation proceeds to step S28004.

In step S28007, the RAHT unit 2080 determines whether the decoding has been completed for all the nodes in all the hierarchies.

When the decoding has not been completed for all the nodes in all the hierarchies, the present operation moves the processing target hierarchy to the one level-lower hierarchy, and proceeds to step S28004. When the decoding has been completed for all the nodes in all the hierarchies, the present operation proceeds to step S28008, and the processing ends.

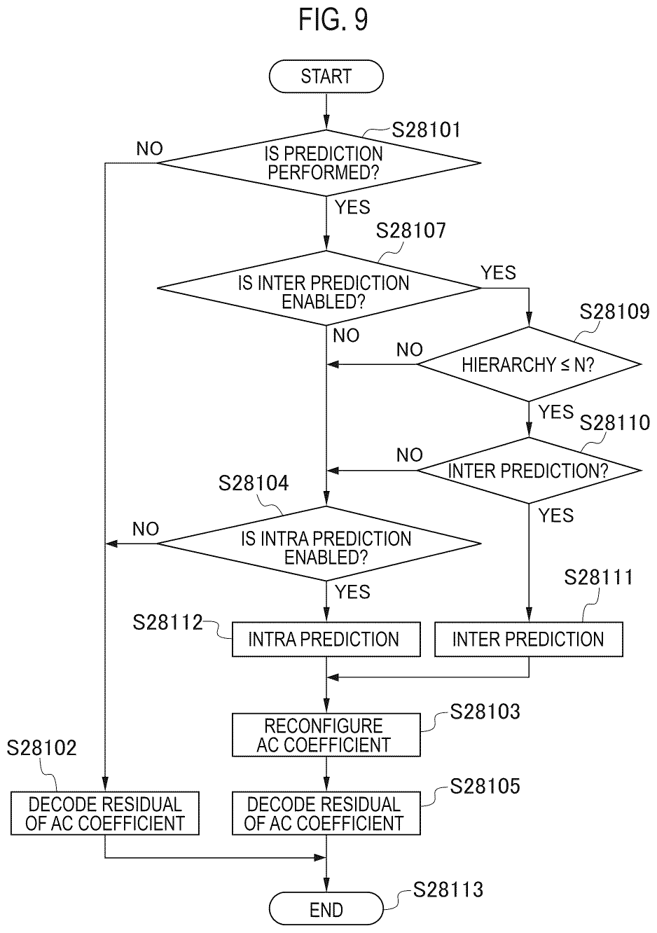

FIG. 9 is a flowchart illustrating an example of processing in step S28004.

As illustrated in FIG. 9, in step S28101, the RAHT unit 2080 determines whether to predict an AC coefficient. When making such a determination, the RAHT unit 2080 may refer to raht_prediction_enabled and use the value thereof.

The RAHT unit 2080 may decode the flag indicating whether to predict the AC coefficient in the current processing target node, and use the value of the flag.

Such a flag may be decoded for each node or may be decoded for each hierarchy. Such a flag may be decoded only when the value of raht_prediction_enabled is “1”, which is a value indicating that prediction is enabled. Such a flag may be included in the slice data.

As a result of the determination, when the AC coefficient is not predicted, the present operation proceeds to step S28102, and when the AC coefficient is predicted, the present operation proceeds to steps S28103 and S28104.

In step S28102, the RAHT unit 2080 decodes the AC coefficient. After the decoding is completed, the present operation proceeds to step S28113, and the processing ends.

In step S28107, the RAHT unit 2080 determines whether or not inter prediction is enabled.

For the determination, the RAHT unit 2080 may refer to and use a value of raht_inter_prediction_enabled.

As a result of the determination, in a case where inter prediction is enabled, the present operation proceeds to step S28109, and in a case where inter prediction is disabled, the present operation proceeds to step S28112.

In step S28109, the RAHT unit 2080 determines whether or not a depth of the hierarchy including the processing target node is equal to or smaller than a threshold. The RAHT unit 2080 may refer to a value of raht_inter_prediction_depth_minus1 as the threshold and use the value.

As a result of the determination, in a case where the depth is equal to or smaller than the threshold, the present operation proceeds to step S28110, and in a case where the depth is larger than the threshold, the present operation proceeds to step S28104.

In step S28110, the RAHT unit 2080 determines whether or not to perform inter prediction on the AC coefficient of the processing target node.

For the determination, the RAHT unit 2080 may check whether or not inter prediction is executable, and does not have to perform inter prediction in a case where the inter prediction is executable. This will be described in detail later.

For the determination, the RAHT unit 2080 may decode a flag indicating whether or not to perform inter prediction on the AC coefficient of the processing target node, and use a value of the flag. Such a flag may be decoded for each node or may be decoded for each hierarchy. Such a flag may be decoded only in a case where the RAHT unit 2080 determines that inter prediction is executable, and a determination may be made. Such a flag may be included in the slice data.

Such a flag may refer to raht_attr_layer_code_mode and use a value thereof. Such a value may be referred to in a case where the depth of the hierarchy including the processing target node is smaller than layer_code_depth and the depth of the hierarchy including the processing target node is larger than the hierarchy of the root node.

That is, such a value may be referred to when depth-1<layer_code_depth and depth-1≥0.

Here, the depth is defined as “O” in the hierarchy of the root node, and is a value counted up as the hierarchy becomes deeper.

In a case where reference is not made, the RAHT unit 2080 may determine that inter prediction is not executable.

In a case where the RAHT unit 2080 determines that inter prediction is executable, the present operation proceeds to step S28111, and in a case where the RAHT unit 2080 determines that inter prediction is not executable, the present operation proceeds to step S28104.

In step S28111, the RAHT unit 2080 performs inter prediction on the AC coefficient of the processing target node. This will be described in detail later.

In step S28104, the RAHT unit 2080 determines whether or not to perform intra prediction on the AC coefficient of the processing target node.

For example, the RAHT unit 2080 may determine whether or not the number of adjacent nodes of the parent node and the grandparent node of the processing target node is equal to or larger than a threshold, determine to perform intra prediction in a case where the number of adjacent nodes is equal to or larger than the threshold, and determine not to perform intra prediction in a case where the number of adjacent nodes is equal to or smaller than the threshold (that is, in a case where the RAHT determines that accuracy in intra prediction of the AC coefficient is not high).

The RAHT unit 2080 may refer to the value of raht_prediction_threshold0 described above and use the value as the threshold for the adjacent nodes of the grandparent node, or may refer to the value of raht_prediction_threshold1 described above and use the value as the threshold for the adjacent nodes of the parent node.

Alternatively, the RAHT unit 2080 may perform additional determination for the processing target node determined to perform intra prediction in the determination using raht_prediction_threshold0 and raht_prediction_threshold1 described above.

That is, in step S28104, the RAHT unit 2080 determines an effect of intra prediction of the AC coefficient of the attribute value by using RAHT. In other words, in step S28104, the RAHT unit 2080 determines whether or not the accuracy in intra prediction of the AC coefficient of the attribute value using RAHT is high.

For example, the RAHT unit 2080 may determine whether or not to perform intra prediction (that is, whether or not the accuracy in intra prediction of the AC coefficient is high) by using the DC coefficient.

Specifically, the RAHT unit 2080 may determine to perform intra prediction in a case where a value obtained by dividing the DC coefficient obtained in step S28006 by the predicted value of the DC coefficient of the processing target node is within a range of a threshold (that is, in a case where the RAHT unit 2080 determines that the accuracy in intra prediction of the AC coefficient is high), and may determine not to perform intra prediction in a case where the value is outside the range of the threshold (that is, in a case where the RAHT unit 2080 determines that the accuracy in intra prediction of the AC coefficient is not high).

Alternatively, the RAHT unit 2080 may determine to perform intra prediction in a case where a value obtained by subtracting the DC coefficient obtained in step S28006 from the predicted value of the DC coefficient of the processing target node is within a range of a threshold (that is, in a case where the RAHT unit 2080 determines that the accuracy in intra prediction of the AC coefficient is high), and may determine not to perform intra prediction in a case where the value is outside the range of the threshold (that is, in a case where the RAHT unit 2080 determines that the accuracy in intra prediction of the AC coefficient is not high).

The RAHT unit 2080 refers to the value of raht_prediction_intra_eligibility_threshold0 and the value of raht_prediction_intra_eligibility_threshold1 described above, and may use such values as the thresholds.

Specifically, the RAHT unit 2080 may determine to perform intra prediction in a case where the value obtained by dividing the DC coefficient obtained in step S28006 by the predicted value of the DC coefficient of the processing target node or the value obtained by subtracting the DC coefficient obtained in step S28006 from the predicted value of the DC coefficient of the processing target node is equal to or larger than the value of raht_prediction_intra_eligibility_threshold0 and equal to or smaller than the value of raht_prediction_intra_eligibility_threshold1 (that is, in a case where the RAHT unit 2080 determines that the accuracy in intra prediction of the AC coefficient is high).

Here, the predicted value of the DC coefficient is a value simultaneously obtained when the predicted value of the attribute value is transformed into the AC coefficient in step S28207 described later, and can be obtained by performing similar processing in step S28104.

In a case where the RAHT unit 2080 determines not to perform intra prediction, the present operation proceeds to step S28102, and in a case where the RAHT unit 2080 determines to perform intra prediction, the present operation proceeds to step S28112.

In step S28112, the RAHT unit 2080 performs intra prediction on the AC coefficient of the processing target node. This will be described in detail later.

In step S28103, the RAHT 2080 decodes the residual of the AC coefficient. After the decoding is completed, the present operation proceeds to step S28105.

In step S28105, the RAHT unit 2080 adds the decoded residual of the AC coefficient and the predicted AC coefficient to reconfigure the AC coefficient. After the reconfiguration is completed, the present operation proceeds to step S28106, and the processing ends.

Note that the conditional branch in step S28109 may be omitted.

In the processing of inter prediction in step S28111, processing equivalent to the intra prediction in step S28112 may be performed together, and prediction may be performed by combining the results of the inter prediction and the intra prediction. This will be described in detail later.

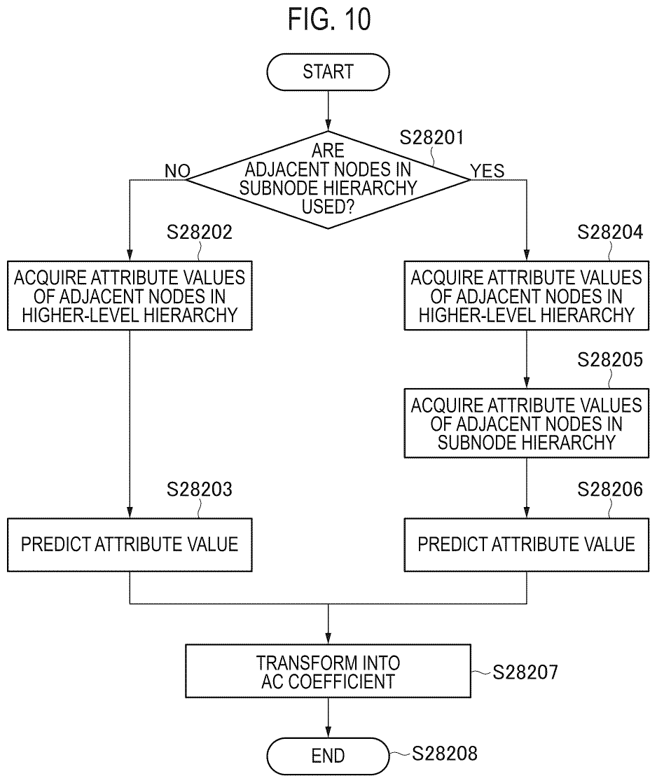

FIG. 10 is a flowchart illustrating an example of processing of intra prediction in step S28112.

As illustrated in FIG. 10, in step S28201, the RAHT unit 2080 determines whether to perform intra prediction using adjacent nodes in the subnode hierarchy.

For the determination, the RAHT unit 2080 may refer to raht_subnode_prediction_enable_flag and use the value thereof.

When adjacent nodes in the subnode hierarchy are not used, the RAHT unit 2080 performs intra prediction only using adjacent nodes in a higher-level hierarchy.

Here, the adjacent nodes in the higher-level hierarchy are 7 nodes, including 3 nodes face-adjacent to the decoding target node, 3 nodes edge-adjacent to the decoding target node, and the parent node itself, among a total of 19 nodes, including 6 nodes face-adjacent to the parent node of the decoding target node, 12 nodes edge-adjacent to the parent node of the decoding target node, and the parent node itself.

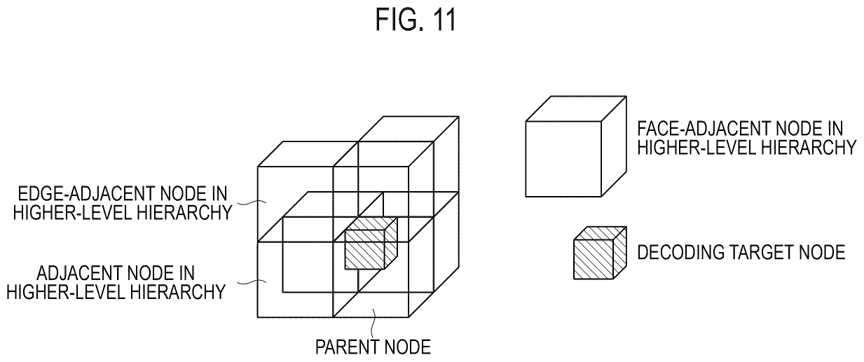

FIG. 11 is a diagram illustrating a relationship between a decoding target node and an adjacent node in a higher-level hierarchy.

When adjacent nodes in the subnode hierarchy are used, the RAHT unit 2080 performs intra prediction using adjacent nodes in the higher-level hierarchy together with the adjacent nodes in the subnode hierarchy.

Here, the adjacent nodes in the subnode hierarchy are decoded nodes face-adjacent or edge-adjacent to the decoding target node among the subnodes of the adjacent nodes in the higher-level hierarchy.

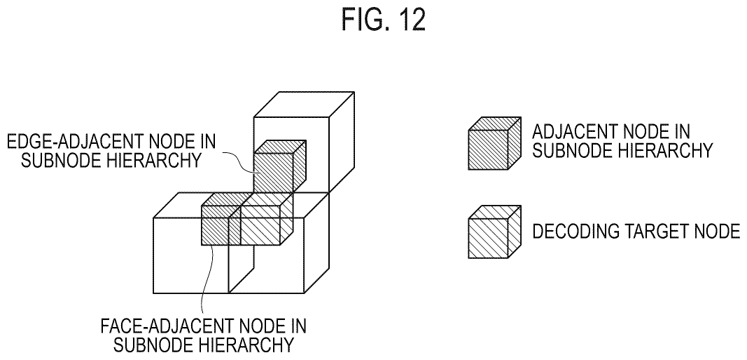

FIG. 12 is a diagram illustrating a relationship between a decoding target node and an adjacent node in a subnode hierarchy.

As a result of the determination, when intra prediction is performed without using adjacent nodes in the subnode hierarchy, the present operation proceeds to step S28202, and when intra prediction is performed using adjacent nodes in the subnode hierarchy, the present operation proceeds to step S28204.

In step S28202, the RAHT unit 2080 acquires attribute values of the adjacent nodes in the higher-level hierarchy. After the attribute values of the adjacent nodes in the higher-level hierarchy are acquired, the present operation proceeds to step S28203.

In step S28203, the RAHT unit 2080 predicts an attribute value of the decoding target node.

The RAHT unit 2080 may predict the attribute value attr according to the following formula, using the acquired attribute values attr₁ of the k adjacent nodes in the higher-level hierarchy and the weights wᵢ according to the types of the adjacent nodes i.

$$attr = \frac{{Σ}_{i} {w}_{i} {attr}_{i}}{{Σ}_{i} {w}_{i}} \qquad [ Math . 5 ]$$

Here, the RAHT unit 2080 may use a hard-coded value as the weight wi depending on what type the adjacent nodes i are of among face-adjacent nodes in the higher-level hierarchy, edge-adjacent nodes in the higher-level hierarchy, and the parent node, or may refer to raht_prediction_weights and calculate the weight wi from the value thereof.

After the prediction of the attribute value is completed, the present operation proceeds to step S28207.

In step S28204, the RAHT unit 2080 acquires attribute values of the adjacent nodes in the higher-level hierarchy.

Here, the targets for which attribute values are obtained are adjacent nodes in the higher-level hierarchy whose subnodes have not yet been decoded, or adjacent nodes in the higher-level hierarchy whose subnodes have been decoded but whose faces or edges are not adjacent to the decoding target node.

After the acquisition of the attribute values is completed, the present operation proceeds to step S28205. In step S28205, the RAHT unit 2080 acquires attribute values of adjacent nodes in the subnode hierarchy. After the attribute values of the adjacent nodes in the subnode hierarchy are acquired, the present operation proceeds to step S28206.

In step S28206, the RAHT unit 2080 predicts an attribute value of the decoding target node.

The RAHT unit 2080 may predict the attribute value attr according to the following formula, using the acquired attribute values attrᵢ of the k adjacent nodes in the higher-level hierarchy and the adjacent nodes in the subnode hierarchy and the weights wᵢ according to the adjacent node type i.

$$attr = \frac{{Σ}_{i} {w}_{i} {attr}_{i}}{{Σ}_{i} {w}_{i}} \qquad [ Math . 6 ]$$

Here, the RAHT unit 2080 may use a hard-coded value as the weight wi depending on what type the adjacent nodes i are of among face-adjacent nodes in the higher-level hierarchy, edge-adjacent nodes in the higher-level hierarchy, the parent node, face-adjacent nodes in the subnode hierarchy, and edge-adjacent nodes in subnode hierarchy, or may refer to raht_prediction_weights and calculate the weight wi from the value thereof.

After the prediction of the attribute value is completed, the present operation proceeds to step S28207.

In step S28207, the RAHT unit 2080 transforms the predicted attribute value into an AC coefficient. The AC coefficient is generated by performing RAHT on the predicted attribute value. For example, the RAHT unit 2080 may use the method described in Non Patent Literature 1 as the transform method.

The RAHT unit 2080 may multiply a transformed predicted value ACᵢₙₜᵣₐ of the AC coefficient by αᵢₙₜᵣₐ with a scaling factor αᵢₙₜᵣₐ.

$$A {C}_{r e d} = {α}_{i n t r a} \times A {C}_{i n t r a}$$

Here, the coefficient αᵢₙₜᵣₐ may be any real number. The coefficient αᵢₙₜᵣₐ may be decoded for each node or may be decoded for each hierarchy. The coefficient αᵢₙₜᵣₐ may be decoded as syntax included in the APS 2611 or the ASH 2612, or may be included in the slice data. The coefficient αᵢₙₜᵣₐ may be hard-coded.

For example, the coefficient αᵢₙₜᵣₐ may be defined using the depth of the hierarchy (depth) as follows, and αᵢₙₜᵣₐ may be decoded instead of the coefficient αᵢₙₜᵣₐ.

$${α}_{intra} = 1 + {α}_{intra}^{′} \times {2}^{- depth}$$

For example, an integer β may be defined to be an integer ranging from an integer a to an integer b, and the RAHT unit 2080 may decode the integer β.

The RAHT unit 2080 may calculate the coefficient αᵢₙₜᵣₐ as a value obtained by adding an integer c to the decoded integer β and then dividing the result by the integer c as follows.

$${α}_{intra} = ( β + c ) / C$$

Here, the RAHT unit 2080 may decode the integer β by using an exponential-Golomb code.

Alternatively, for example, in a case where a decoded value of raht_filter_taps_intra is “X”, the RAHT unit 2080 may subtract X from 128, and use, as the scaling factor αᵢₙₜᵣₐ for inter prediction, a value obtained by shifting the subtraction result to the right by seven bits.

For example, in a case where the value of raht_filter_taps_intra is “0”, a value of a scaling factor αᵢₙₜᵣₐ in inter prediction of the attribute information may be defined as a value “1” obtained by subtracting 0 from 128 and shifting the subtraction result to the right by seven bits.

For example, in a case where the RAHT unit 2080 refers to raht_attr_layer_code_mode and determines that intra prediction is applied to the processing target node, the RAHT unit 2080 may scale an intra-predicted value by using the decoded value of raht_filter_taps_intra.

After the transformation of the AC coefficient is completed, the present operation proceeds to step S28208, and the processing ends.

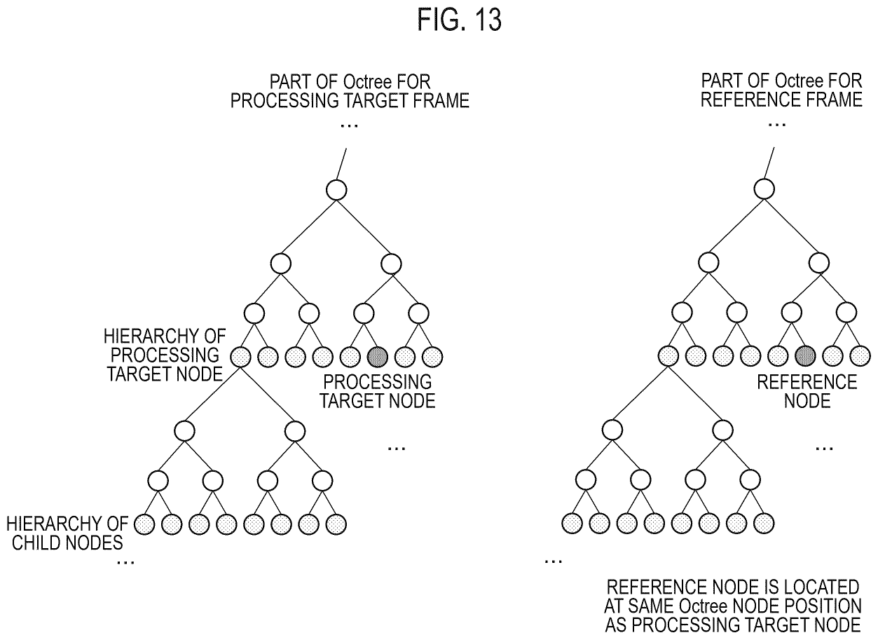

FIG. 13 is a diagram illustrating an example of inter prediction processing in step S28111.

The RAHT unit 2080 predicts AC coefficients of processing target nodes by using information on reference nodes, which are corresponding nodes in the reference frame. Here, the information on reference nodes may be attribute values or AC coefficients thereof.

Furthermore, the reference frame refers to another decoded frame, and the information thereof may be included in a pre-frame buffer 2120.

The RAHT unit 2080 may apply the same octree structure to the reference frame as the processing target frame. In such a case, a node may be set at a position where there is no point. Such a node is referred to as an empty node. When the reference node is an empty node, the RAHT unit 2080 may disable inter prediction in step S28110.

The RAHT unit 2080 may apply an octree to the reference frame independently of the processing target frame, and set a different octree structure to the reference frame from the processing target frame. In such a case, there is a possibility that nodes do not necessarily exist at the same positions as those in the processing target frame. When no reference node is found at the position corresponding to the processing target node, the RAHT unit 2080 may disable inter prediction in step S28143.

When the reference node is an empty node or when no reference node is found, the RAHT unit 2080 may estimate and interpolate information on the reference node by using information on nodes at nearby positions in the reference frame.

For example, the RAHT unit 2080 may estimate and interpolate an average value of attribute values or AC coefficients of the adjacent nodes, the nearest nodes, or the k nearest nodes with respect to the reference node position as the attribute value or the AC coefficient of the reference node.

The RAHT unit 2080 may apply the above-described interpolation only to a specific hierarchy and subsequent hierarchies.

In a case where the RAHT unit 2080 determines that encoding efficiency is higher when the AC coefficient of the attribute value is not decoded, the RAHT unit 2080 may skip decoding of an AC coefficient of an attribute value of a node of a hierarchy under the processing target node.

Specifically, in a case where the number of decoding target nodes becomes two or less in the parent node including the processing target node, in a case where the value of the decoded AC coefficient becomes equal to or less than a threshold, or in a case where the number of decoding target nodes becomes two or less and the value of the decoded AC coefficient becomes equal to or less than the threshold, the RAHT unit 2080 may determine that the encoding efficiency is higher when the AC coefficient of the attribute value is not decoded, and skip decoding of an AC coefficient of a node of a hierarchy under the processing target node.

Here, such a threshold may be a hard-coded value, or may be used with reference to a value of raht_prediction_skip_threshold.

In addition, the skipping of the decoding of an AC coefficient of a hierarchy under the processing target node described above may be applied only to a specific hierarchy and subsequent hierarchies.

The RAHT unit 2080 may predict the AC coefficient of the processing target node, for example, from the attribute value of the reference node.

Specifically, the RAHT unit 2080 may obtain a predicted value Attr_{pred} of the attribute value of the processing target node by using a value Attrᵢₙₜₑᵣ of the decoded attribute value of the reference node, and obtain a predicted value AC_{pred} of the AC coefficient of the processing target node by applying RAHT to the predicted value Attr_{pred} of the attribute value of the processing target node.

$${Attr}_{pred} = {Attr}_{inter}$$

$${AC}_{pred} = RAHT ( {Attr}_{pred} )$$

The RAHT unit 2080 may directly predict the AC coefficient of the processing target node, for example, from the AC coefficient of the reference node.

Specifically, the RAHT unit 2080 may calculate a value ACᵢₙₜₑᵣ of the AC coefficient of the reference node by using RAHT in the reference frame, and use the value as the predicted value AC_{pred} of the AC coefficient of the processing target node.

$${AC}_{pred} = {AC}_{inter}$$

The RAHT unit 2080 may obtain the AC coefficient of the reference node by recording the AC coefficient of each node of the reference frame in the frame buffer 2120 and referring to the value in the frame buffer 2120. In such a case, in a case where the AC coefficient of the reference node does not exist in the frame buffer 2120, the RAHT unit 2080 may disable inter prediction in step S28110.

Note that the RAHT unit 2080 may multiply each of Attrᵢₙₜₑᵣ and the ACᵢₙₜₑᵣ by a with a scaling factor x.

$${Attr}_{pred} = α {Attr}_{inter} or {AC}_{pred} = α {AC}_{inter}$$

The coefficient α may take any real number. The coefficient α may be decoded for each node or may be decoded for each hierarchy. The coefficient α may be decoded as syntax included in the APS 2611 or the ASH 2612, or may be included in the slice data.

For example, the coefficient α may be defined using the depth of the hierarchy as follows, and α′ may be decoded instead of the coefficient α.

$$α = 1 + {α}^{′} \cdot 2 - depth$$

For example, the integer β may be defined to be an integer ranging from integer a to integer b, and β may be decoded. The coefficient α may be calculated as a value obtained by adding integer c to the decoded B and then dividing the result by the integer c as follows.

$$α = ( β + c ) / c$$

The integer β may be decoded using an exponential-Golomb code.

Alternatively, for example, in a case where the decoded value of raht_filter_taps is “X”, the RAHT unit 2080 may subtract X from 128, and use, as the scaling factor α for inter prediction, a value obtained by shifting the subtraction result to the right by seven bits.

For example, in a case where the value of raht_filter_taps is “0”, the value of the scaling factor α in inter prediction of the attribute information may be defined as a value “1” obtained by subtracting 0 from 128 and shifting the subtraction result to the right by seven bits.

For example, the RAHT unit 2080 may determine whether to apply inter prediction on the basis of syntax that specifies a hierarchy to which inter prediction is applied, and may scale the inter-predicted value using the decoded value of raht_filter_taps in a case where the RAHT unit 2080 determines to apply inter prediction in the hierarchy.

On the other hand, in a case where the RAHT unit 2080 determines not to apply the scaling of inter prediction in such a hierarchy, the RAHT unit 2080 does not have to scale inter prediction.

Specifically, the RAHT unit 2080 may determine to scale an inter-predicted value in a case where the depth of the hierarchy including the processing target node is equal to or smaller than the number of valid hierarchies of inter prediction, and the depth of the hierarchy including the processing target node is equal to or larger than the value indicating how many higher layers are excluded from scaling application of inter prediction.

Here, the RAHT unit 2080 may refer to the value of raht_inter_prediction_depth_minus1 and use the value as the number of valid hierarchies of inter prediction.

In addition, the RAHT unit 2080 may refer to the value of raht_inter_skip_layers and use the value as the value indicating how many higher layers are excluded from scaling application of inter prediction.

Alternatively, for example, the RAHT unit 2080 may determine to scale the inter-predicted value in a case where the depth of the hierarchy including the processing target node is equal to or smaller than the number of valid hierarchies of inter prediction, the depth of the hierarchy including the processing target node is equal to or larger than the value indicating how many higher layers are excluded from scaling application of inter prediction, and the RAHT unit 2080 determines to apply inter prediction in the hierarchy including the processing target node.

Here, the RAHT unit 2080 may refer to the value of raht_attr_layer_code_mode described above in the hierarchy including the processing target node, and determine whether or not to apply inter prediction based on the value.

Alternatively, the RAHT unit 2080 may determine to scale the inter-predicted value in a case where the depth of the hierarchy including the processing target node is equal to or larger than the value indicating how many higher layers are excluded from scaling application of inter prediction.

Here, the RAHT unit 2080 may refer to the value of raht_inter_skip_layers and use the value as the value indicating how many higher layers are excluded from scaling application of inter prediction.

Although a case where the number of scaling factors for each hierarchy is one has been described above, for example, even in a case where the scaling factor is transmitted for each frequency index idx of the AC coefficient, the number of scaling factors to be decoded can be derived by multiplying the number of scaling factors calculated above by the number of scaling factors for each hierarchy. The number of scaling factors may be, for example, seven.

For example, the coefficient α may be calculated using an AC coefficient ACₚₐᵣₑₙₜ of the parent node of the decoding target node and an inter-predicted value ACₚₐᵣₑₙₜ inter obtained when the parent node is decoded as follows.

$$α = {AC}_{parent} / {AC}_{parent \_ inter}$$

For example, x may be calculated so as to minimize the cost using AC coefficients AC_{neighbor1}, AC_{neighbor2}, . . . “and AC_{neighborN} of N adjacent nodes of the decoding target node and inter-predicted values AC_{neighbor_inter1}, AC_{neighbor_inter2}, . . . , and AC_{neighbor_interN} obtained when the respective adjacent nodes are decoded.

The cost may be, for example, the sum of squared errors between the AC coefficients of the respective adjacent nodes and the predictors of the AC coefficients. For example, the adjacent nodes may be only face-adjacent nodes, or may be face-adjacent nodes and edge-adjacent nodes.

The RAHT unit 2080 may perform a similar operation by inter prediction of DC coefficients in step S28003.

$$D {C}_{p r e d} = α D {C}_{i n t e r}$$

Here, the DC coefficient of the reference node is defined as DCᵢₙₜₑᵣ, and the predicted value of the DC coefficient of the root node is DC_{pred}.

In addition, the RAHT unit 2080 may calculate a predicted value of an attribute value or an AC coefficient by combining inter prediction and intra prediction.

For example, an example in which the RAHT unit 2080 obtains a predicted value of an attribute value will be described below.

$$A t t {r}_{p r e d} = {W}_{i n t e r} \cdot {Attr}_{i n t e r} + {W}_{i n t r a} \cdot {Attr}_{i n t r a}$$

Here, Attrᵢₙₜₑᵣ and Attrᵢₙₜᵣₐ are inter prediction and intra prediction of the attribute value, respectively. In addition, Wᵢₙₜₑᵣ and Wᵢₙₜᵣₐ are weights of inter prediction and intra prediction, respectively.

Wᵢₙₜₑᵣ and Wᵢₙₜᵣₐ may be determined depending on the depth of the processing target hierarchy such that the deeper the hierarchy, the more importance is placed on intra prediction. For example,

$${W}_{inter} = 1 - depth / N$$

$${W}_{intra} = depth / N$$

N is a maximum value of the depth of the hierarchy in which inter prediction is enabled. The combination of inter prediction and intra prediction may be enabled only in a specific hierarchy. For example, the combination of inter prediction and intra prediction may be enabled only when M<depth<N. M may be any real number less than N, and may be decoded as header information such as APS.

For example, the RAHT unit 2080 may perform bidirectional prediction. Hereinafter, an example of an operation of the RAHT unit 2080 when bidirectional prediction is performed will be described.

First, the RAHT unit 2080 groups a certain number of frames to be processed, and processes the frames by changing a processing order in the group.

For example, the RAHT unit 2080 may regard eight frames as one group and may perform processing from the frame with the in-group frame index of 0 to the frame with the in-group frame index of 7 in the order of 0, 7, 1, 2, 3, 4, 5, and 6.

Here, the in-group frame index is a number assigned for each order of the frame to be processed in the group.

Furthermore, there may be two reference frames at the time of inter prediction for each processing target frame, and a frame to be referred to may be a future frame in time series.

The in-group frame index order pattern and the frame referred to by the in-group frame index may be decoded as a flag included in the APS 2611 or the ASH 2612.

Further, the RAHT unit 2080 may decode the in-group frame index order pattern and the frame referred to by the in-group frame index by referring to the value of biPredictionPrediod and using the value.

Here, the in-group frame index order pattern is a pattern of the order of the in-group frame indexes.

Alternatively, raht_attr_layer_code_mode may include a flag indicating whether or not to perform intra prediction, inter prediction, no prediction, or bidirectional prediction for each hierarchy.

Furthermore, in a case where there are a plurality of in-group frame index order patterns in bidirectional prediction, raht_attr_layer_code_mode described above may include the flags as many as the number of variations thereof.

Furthermore, the RAHT unit 2080 may prepare a list of the reference frames and select a frame to be referred to by each in-group frame index from the list based on a value of the decoded index in the list.

The RAHT unit 2080 may prepare, as the lists of the reference frames, two lists of past frames and future frames in time series based on the processing target frame, and may update the reference frame lists at a timing for processing each frame.

In addition, the RAHT unit 2080 may fix the frame to be referred to by each in-group frame index for each in-group frame index order pattern and perform hard coding.

In addition, the RAHT unit 2080 may decode raht_attr_layer_code_mode described above for each slice or for each hierarchy.

### (Point Cloud Encoding Device 100)

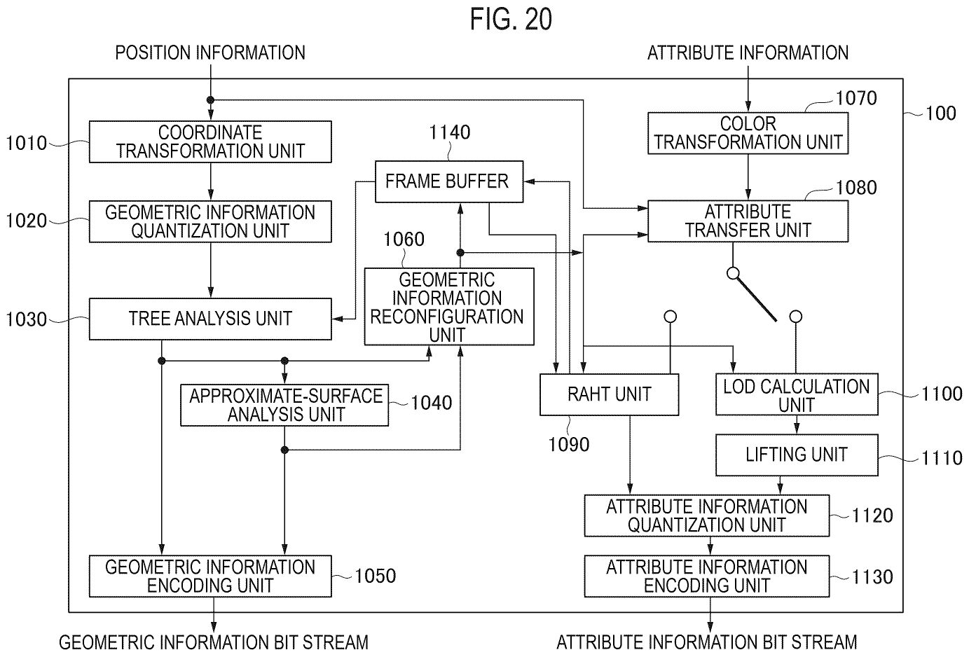

Hereinafter, the point cloud encoding device 100 according to the present embodiment will be described with reference to FIG. 20. FIG. 20 is a diagram illustrating an example of functional blocks of the point cloud encoding device 100 according to the present embodiment.

As illustrated in FIG. 20, the point cloud encoding device 100 includes a coordinate transformation unit 1010, a geometry information quantization unit 1020, a tree analysis unit 1030, an approximate-surface analysis unit 1040, a geometry information encoding unit 1050, a geometry information reconfiguration unit 1060, a color transformation unit 1070, an attribute transfer unit 1080, an RAHT unit 1090, an LoD calculation unit 1100, a lifting unit 1110, an attribute-information quantization unit 1120, an attribute-information encoding unit 1130, and a frame buffer 1140.

The coordinate transformation unit 1010 is configured to perform transformation processing from a three-dimensional coordinate system of an input point cloud to an arbitrary different coordinate system. In the coordinate transformation, for example, x, y, and z coordinates of the input point cloud may be transformed into arbitrary s, t, and u coordinates by rotating the input point cloud. Furthermore, as one of variations of the transformation, the coordinate system of the input point cloud may be used as it is.

The geometry information quantization unit 1020 is configured to perform quantization of position information of the input point cloud after the coordinate transformation and removal of points having overlapping coordinates. Note that, in a case where a quantization step size is 1, the position information of the input point cloud matches position information after quantization. That is, a case where the quantization step size is 1 is equivalent to a case where quantization is not performed.

The tree analysis unit 1030 is configured to generate an occupancy code indicating which node in an encoding target space a point is present, based on a tree structure to be described later, by using the position information of the point cloud after quantization as an input.

In the present processing, the tree analysis unit 1030 is configured to recursively partition the encoding target space into cuboids to generate the tree structure.

Here, in a case where a point is present in a certain cuboid, the tree structure can be generated by recursively performing processing of dividing the cuboid into a plurality of cuboids until the cuboid has a predetermined size. Each of such cuboids is referred to as a node. In addition, each cuboid generated by dividing the node is referred to as a child node, and the occupancy code is a code expressed by 0 or 1 as to whether or not a point is included in the child node.

As described above, the tree analysis unit 1030 is configured to generate the occupancy code while recursively dividing the node to a predetermined size.

In the present embodiment, it is possible to use a method called “octree” in which octree division is recursively carried out with the above-described cuboids always as cubes, and a method called “QtBt” in which quadtree division and binary tree division are carried out in addition to octree division.

Here, whether or not to use “QtBt” is transmitted to the point cloud decoding device 200 as control data.

Alternatively, it may be designated that Predictive geometry coding that uses any tree configuration is to be used. In such a case, the tree analysis unit 1030 determines the tree structure, and the determined tree structure is transmitted to the point cloud decoding device 200 as control data.

For example, the control data of the tree structure may be configured to be decoded by the procedure described in FIGS. 5 to 14.

The approximate-surface analysis unit 1040 is configured to generate approximate-surface information by using the tree information generated by the tree analysis unit 1030.

For example, in a case where a point cloud is densely distributed on the surface of an object when decoding three-dimensional point cloud data of the object or the like, the approximate-surface information approximates and expresses a region in which the point cloud is present by a small plane instead of decoding each point cloud.

Specifically, the approximate-surface analysis unit 1040 may be configured to generate the approximate-surface information by, for example, a method called “Trisoup”. In addition, when decoding a sparse point cloud acquired by Lidar or the like, the present processing can be omitted.

The geometry information encoding unit 1050 is configured to encode syntax such as the occupancy code generated by the tree analysis unit 1030 and the approximate-surface information generated by the approximate-surface analysis unit 1040 to generate a bit stream (geometry information bit stream). Here, the bit stream may include, for example, the syntax described with reference to FIG. 4.

The encoding processing is, for example, context-adaptive binary arithmetic encoding processing. Here, for example, the syntax includes control data (flags and parameters) for controlling the decoding processing of the position information.

The geometry information reconfiguration unit 1060 is configured to reconfigure geometry information (a coordinate system assumed by the encoding processing, that is, the position information after the coordinate transformation in the coordinate transformation unit 1010) of each point of the point cloud data to be encoded based on the tree information generated by the tree analysis unit 1030 and the approximate-surface information generated by the approximate-surface analysis unit 1040.

The frame buffer 1140 is configured to use, as input, the geometry information reconfigured by the geometry information reconfiguration unit 1060 and store the geometry information as a reference frame.

The stored reference frame is read from the frame buffer 1140 and used as a reference frame in a case where the tree analysis unit 1030 performs inter prediction of temporally different frames.

Here, which time reference frame is used for each frame may be determined based on, for example, a value of a cost function representing encoding efficiency, and information of the reference frame to be used may be transmitted to the point cloud decoding device 200 as the control data.

The color transformation unit 1070 is configured to perform color transformation when attribute information of the input is color information. The color transformation is not necessarily performed, and whether or not to perform the color transformation processing is encoded as a part of the control data and transmitted to the point cloud decoding device 200.

The attribute transfer unit 1080 is configured to correct an attribute value so as to minimize distortion of the attribute information based on the position information of the input point cloud, the position information of the point cloud after the reconfiguration in the geometry information reconfiguration unit 1060, and the attribute information after the color change in the color transformation unit 1070. As a specific correction method, for example, the method described in Non Patent Literature 1 can be applied.

The RAHT unit 1090 is configured to receive, as input, the attribute information transferred by the attribute transfer unit 1080 and the geometric information generated by the geometric information reconfiguration unit 1060, and to generate residual information for each point by using a type of Haar transform called region adaptive hierarchical transform (RAHT).

The information to be decoded includes DC components (DC coefficients) and AC components (AC coefficients) of the attribute information generated by using RAHT in encoding processing, and is transformed into the attribute information by using inverse transform of RAHT in decoding processing.

As specific RAHT processing, for example, the method described in Non Patent Literature 1 described above can be used.

The LoD calculation unit 1100 is configured to generate a level of detail (LoD) using the geometry information generated by the geometry information reconfiguration unit 1060 as an input.

The LoD is information for defining a reference relationship (a point that refers to and a point to be referred to) for implementing predictive coding such as encoding or decoding of a prediction residual by predicting attribute information of a certain point from attribute information of another certain point.

In other words, the LoD is information defining a hierarchical structure in which each point included in the geometry information is classified into a plurality of levels, and for a point belonging to a lower level, an attribute is encoded or decoded using attribute information of a point belonging to an upper level.

As a specific LoD determination method, for example, the method described in Non Patent Literature 1 described above may be used.

The lifting unit 1110 is configured to generate the residual information by lifting processing using the LoD generated by the LoD calculation unit 1100 and the attribute information after the attribute transfer in the attribute transfer unit 1080.

As specific processes of the lifting, for example, the method described in Non Patent Literature 1 described above may be used.

The attribute-information quantization unit 1120 is configured to quantize the residual information output from the RAHT unit 1090 or the lifting unit 1110. Here, a case where the quantization step size is 1 is equivalent to a case where quantization is not performed.

The attribute-information encoding unit 1130 is configured to perform encoding processing using the quantized residual information or the like output from the attribute-information quantization unit 1120 as syntax to generate a bit stream (attribute information bit stream) regarding the attribute information.

The encoding processing is, for example, context-adaptive binary arithmetic encoding processing. Here, for example, the syntax includes control data (flags and parameters) for controlling the decoding processing of the attribute information.

The point cloud encoding device 100 is configured to perform the encoding processing using the position information and the attribute information of each point in a point cloud as inputs and output the geometry information bit stream and the attribute information bit stream by the above processing.

According to the present embodiment, whether or not to apply intra prediction of the AC coefficient is determined using the DC coefficient, and a code amount of the AC coefficient to be decoded is reduced and the coding efficiency is improved by performing intra prediction in a case where it is determined in advance that the accuracy in intra prediction is high, and not performing the prediction in a case where it is determined that the accuracy in intra prediction is not high.

Furthermore, according to the present embodiment, by scaling an intra-predicted attribute value or the AC coefficient obtained by performing RAHT of the attribute value, prediction accuracy is improved, the number of residuals to be decoded is reduced, and the encoding efficiency is improved.

The point cloud encoding device 100 and the point cloud decoding device 200 described above may be implemented as programs that cause a computer to execute each function (each step).

In the above embodiments, the present invention has been described using the application to the point cloud encoding device 100 and the point cloud decoding device 200 as an example. However, the present invention is not limited to such examples and can similarly be applied to a point cloud encoding/decoding system that incorporates the respective functions of the point cloud encoding device 100 and the point cloud decoding device 200.

According to the present embodiment, for example, comprehensive improvement in service quality can be realized in moving image communication, and thus, it is possible to contribute to the goal 9 “Build resilient infrastructure, promote inclusive and sustainable industrialization and foster innovation” of the sustainable development goal (SDGs) established by the United Nations.

What is claimed is:

1. A point cloud decoding device comprising:
an attribute-information decoding unit configured to decode a value indicating the number of inter prediction applicability modes in a target slice, wherein
the value is set to be equal to a smaller value of a value obtained by subtracting 1 from the number of hierarchies of the target slice and a value obtained by subtracting 1 from the number of hierarchies in which inter prediction of attribute information is enabled.

2. A point cloud decoding method comprising:
decoding a value indicating the number of inter prediction applicability modes in a target slice, wherein
the value is set to be equal to a smaller value of a value obtained by subtracting 1 from the number of hierarchies of the target slice and a value obtained by subtracting 1 from the number of hierarchies in which inter prediction of attribute information is enabled.

3. A non-transitory computer-readable medium having stored thereon a program for causing a computer to function as a point cloud decoding device, wherein
the point cloud decoding device includes an attribute-information decoding unit configured to decode a value indicating the number of inter prediction applicability modes in a target slice, and the value is set to be equal to a smaller value of a value obtained by subtracting 1 from the number of hierarchies of the target slice and a value obtained by subtracting 1 from the number of hierarchies in which inter prediction of attribute information is enabled.
